(19) United States
(12) Patent Application Publication
(10) Pub. No.: US 2007/0106544 A1
(43) Pub. Date: May 10, 2007

(54) E-MANAGEMENT MARKET METHOD

(76) Inventor: Angela Joyce Burth, Arlington, VA (US)

Correspondence Address: ANGELA J. BURTH, 1401 S. JOYCE ST., # 1517, ARLINGTON, VA, 22202, US

(21) Appl. No.: 11/555,239

(22) Filed: Oct. 31, 2006

Related U.S. Application Data
(60) Provisional application No. 60/733,718, filed on Nov. 4, 2005.

(51) Int. Cl. G05B 19/418

(52) U.S. Cl. 705/8

(57) ABSTRACT

A method to develop, implement, operate and maintain a market-based management strategy with the application of commercial market practices. An e-management market is developed to meet the business activities defined by an organization, community of interest, or community of practice in need of a results based management technique to replace their ineffective management practices. The present invention achieves an e-management technique in four phases. During the first define and initiate phase, the community is defined and the scope of the business activities that will be completed with the new management structure are identified. The second phase is the plan, design, and develop phase where e-management market functions are designed to meet the needs of the defined community and implemented. The third phase is the operational phase, and contains all of the management transaction activity for the e-management market. The ongoing life-cycle maintenance phase includes reports and summaries as well as the change management activities for the e-management market.

### CROSS-REFERENCE TO RELATED APPLICATION

This application claims priority from U.S. Provisional Application Ser. No. 60/733,718 filed Nov. 4, 2005. The entirety of that provisional application is incorporated herein by reference.

### BACKGROUND OF THE INVENTION—FIELD OF INVENTION

The present invention generally relates to developing a management system, specifically to developing and using an alternative management strategy and method for organizations or communities to replace existing traditional management methods with the application of e-commerce practices.

### BACKGROUND OF THE INVENTION—PRIOR ART

Decision-making, management, and information sharing processes in the federal government, military, state, and other large hierarchical organizations are based on old stovepiped information flows and capabilities. Today, there is ample evidence of the need for change to improve effectiveness and competitive advantage, reduce spending, achieve self-synchronized command and control (management), and capitalize on the collective knowledge and resources dispersed throughout organizations and communities. One problem to address today is approximately half of federal government employees are expected to retire in the next few years. The government has a great need to capture the knowledge of its aging workforce. Currently there is very little motivation or method to share their knowledge or information. Equally, there is little motivation to solve another organization's problems. Often personnel skills are locked into a single job, and not given the opportunity to benefit efforts considered “out of job scope”. A strategy and method needs to be developed to answer and fix these problems. Know how must be captured and utilized and the “power of the many” should be consulted and motivated to improve effectiveness.

Another very clear illustration of such failings was shown during Hurricane Katrina. In Katrina our Federal Government was unable quickly to stand-up a management structure to respond to the entire scope of the disaster or manage the activities of all responders. A disaster scenario is a superb example of a complex and dynamic environment that requires a responsive and flexible management structure and method. Command and control by one central authority just doesn't work well for a disaster event; there are too many authorities, too many constraints, too many responders, too many problems, and disaster plans rarely cover everything that is needed. Stovepiped requirement processes where requirements are coordinated by third party, routed only to one organization, and are not visible by all possible responders are not effective.

### BACKGROUND OF THE INVENTION—OBJECTS AND ADVANTAGES

What was needed during Katrina was one place to communicate and record a need (demand) for which all possible responders could review and present their options (supply). A statement of demand is a powerful motivator, especially during disaster events. A range of responders stand ready to solve problems where they can; previously unconsidered sources may provide solutions to unplanned problems. Organizational constraints and exceptions can often be resolved when demand is known and the motivation to meet it exists. The advantages of using a market based strategy as a management technique are numerous. The basics rules of supply and demand persist in business activities of all types: Resource, personnel, and capability availability; information or knowledge exchanges—what's needed, who has it, or where is it; planning activities to determine the best use of existing resources and identify gaps. All of these typical business activities can be thought of as transactions, the application of supply against demand. E-management market transactions establish a recorded value, with monetary exchanges being a rare means for measuring that value. Commerce is not the purpose or focus of e-management markets; results-based decision making, self-synchronized command and control, and value-added knowledge and information exchanges, and other business activity management provide e-management market focus and purpose. A market-based management strategy can answer the “what's in it for me” question, while at the same time providing objective measures of effectiveness, speed to solution, and enabling the knowledge and power of the many to solve organizational or community requirements.

What does current information age technology let us do in this regard? Online auctions serve as a good example of successful transformation. An online auction allows a consumer anywhere in the world to establish a one-time relationship with someone they have never met. Online virtual auctions accomplish thousands of successful transactions each day. The virtual market created by online auctions establishes an environment with enough information and trust factors built in for the decision-making consumer to participate in ad-hoc transactions. Three primary enablers were necessary to make this happen: web-technology, new processes, and changed culture. Each enabler was necessary to achieve successful transformation. It wasn't enough that technology improved, processes were changed to take advantage of the new technical advantage, and finally the community of practice accepted both technology and process changes resulting in a culture change. Transformation is achieved in the overlapping domain between people, process, and technology.

What made this happen? The first enabler, web-based technology, is nearly ubiquitous today. Consumer savings, convenience, and the extension of the public auction into virtual space motivated a change in the second enabler, the consumer buying process. On-line auctions started with a familiar process, modified it to take advantage of new technology resulting in a new online cultural process. What gave the individuals enough trust to participate and make these transactions happen? Feedback and payment guarantees were built into the new virtual process that helped facilitate the trust and reputation validation necessary to reach the comfort level of consumers already participating in the online culture. The market sets a standard for expected results, and those that do not meet the standard will have fewer transactions. The on-line model shows a transformational change from the introduction of technology, to the adaptation of processes to take advantage of the technology, to the acceptance of the practice by many consumers. Online auctions are now common practice in private commerce; this is a consumer cultural change and successful transformation.

An analogous market approach can be applied to decision-making and management methods. A decision or e-management market strategy extends this familiar e-commerce auction model into the world of command and control (civilian term management), communication, coordination, and knowledge and information sharing. This type of strategy is especially useful for those decisions involving information, actions, and/or resources from numerous sources and disparate locations. E-management markets are designed for an organization, Community of Interest (COI), or Community of Practice (COP) focused on common purposes and missions. A few examples of focused purpose include disaster response and relief, intelligence, and military force application, capability planning, or course of action (COA) selection. This invention builds on a reverse auction method (where the consumer defines demand and providers bid to meet that demand) to attain solutions, along with other e-commerce practices. The difference from the e-commerce method is that monetary exchanges are rarely part of transactions. Instead each transaction has a recorded value and may be thought of as a type of internal organizational or community billing. These recorded values must matter in some way, providing a motivation to participate and incentives to improve response, processes, and products. Applications are limited only by the desire to improve current coordination or management techniques and where basic market mechanics can be identified. A market-based strategy is a prescribed stimulant to transform organizational culture and management practices. This type of cultural change improves decision-making and takes advantage of net-centric capabilities. Some improvements over existing management methods include:
Competition and motivation to participate and perform
Established and recorded value for resources and services
Flexible and adaptable scope management
Measures of performance, feedback, & metrics
Indicators of success, failure, and capability shortfalls shown by demand analysis
Decision making outside of traditional hierarchies
Command and control structure that can be activated within minutes for complex events
Value-added roles and responsibilities for middle management as brokers
Global reach to resources
Self-synchronized command and control

### SUMMARY OF THE INVENTION

The present invention describes an end-to-end method to develop, implement, operate and maintain a market-based management strategy with the application of commercial market practices. An e-management market is developed to meet the business activities defined by an organization, community of interest, or community of practice in need of a results-based management technique to replace their inefficient management practices. The present invention achieves an e-management technique in four phases. During the first define and initiate phase, the community is defined and the scope of the business activities that will be completed with the new e-management structure and method are identified. The second phase is the plan, design, and develop phase where e-management market functions are designed to meet the needs of the defined community and implemented. The third phase is the operational phase, and contains all of the management transaction activity for the e-management market. The ongoing life-cycle maintenance phase includes reports and summaries as well as the change management activities for the e-management market.

### BRIEF DESCRIPTION OF THE FIGURES

FIG. 1 illustrates an overview of a method for developing, operating, and maintaining an e-management market, in accordance with an embodiment of the invention.

FIG. 2 is a flowchart illustrating define and initiate phase A, according to an embodiment of the present invention.

FIG. 3 is a flowchart illustrating initial e-management market scope process 1 steps, according to an embodiment of the present invention showing inputs and outputs.

FIG. 4 is a flowchart illustrating market charter process 2 steps, according to an embodiment of the present invention showing inputs and outputs.

FIG. 5 is a flowchart illustrating plan, design, and develop phase B, according to an embodiment of the present invention.

FIG. 6 is a flowchart illustrating final e-management market scope process 3 steps, according to an embodiment of the present invention showing inputs and outputs.

FIG. 7 is a flowchart illustrating market categories process 4, according to an embodiment of the present invention showing inputs and outputs.

FIG. 8 is a flowchart illustrating market rules and security process 5, according to an embodiment of the present invention showing inputs and outputs.

FIG. 9 is a flowchart illustrating decision criteria process 6, according to an embodiment of the present invention showing inputs and outputs.

FIG. 10 is a flowchart illustrating transaction metrics process 7, according to an embodiment of the present invention showing inputs and outputs.

FIG. 11 is a flowchart illustrating change control process 8 steps, according to an embodiment of the present invention showing inputs and outputs.

FIG. 12 is a flowchart illustrating user agreement process 9 steps, according to an embodiment of the present invention showing inputs and outputs.

FIG. 13 is a flowchart illustrating web-based market functions process 10 steps, according to an embodiment of the present invention showing inputs and outputs.

FIG. 14 is a flowchart illustrating advanced and automated market functions process 11 steps, according to an embodiment of the present invention showing inputs and outputs.

FIG. 15 is a flowchart illustrating registration templates process 12 steps, according to an embodiment of the present invention showing inputs and outputs.

FIG. 16 is a flowchart illustrating requirement and response templates process 13 steps, according to an embodiment of the present invention showing inputs and outputs.

FIG. 17 is a flowchart illustrating feedback templates process 14 steps, according to an embodiment of the present invention showing inputs and outputs.

FIG. 18 is a flowchart illustrating reports and summaries process 15 steps, according to an embodiment of the present invention showing inputs and outputs.

FIG. 19 is a flowchart illustrating other web-based functions process 16 steps, according to an embodiment of the present invention showing inputs and outputs.

FIG. 20 is a flowchart illustrating web-based user interface implementation process 17 steps, according to an embodiment of the present invention showing inputs and outputs.

FIG. 21 is a flowchart illustrating operating phase C, according to an embodiment of the present invention.

FIG. 22 is a flowchart illustrating register & login process 18 steps, according to an embodiment of the present invention showing inputs and outputs.

FIG. 23 is a flowchart illustrating post requirement process 19 steps, according to an embodiment of the present invention showing inputs and outputs.

FIG. 24 is a flowchart illustrating post response process 20 steps, according to an embodiment of the present invention showing inputs and outputs.

FIG. 25 is a flowchart illustrating accept response process 21 steps, according to an embodiment of the present invention showing inputs and outputs.

FIG. 26 is a flowchart illustrating deliver solution process 22 steps, according to an embodiment of the present invention showing inputs and outputs.

FIG. 27 is a flowchart illustrating submit feedback process 23 steps, according to an embodiment of the present invention showing inputs and outputs.

FIG. 28 is a flowchart illustrating life-cycle maintenance phase D, according to an embodiment of the present invention.

FIG. 29 is a flowchart illustrating review and re-validate market charter process 24 steps, according to an embodiment of the present invention showing inputs and outputs.

FIG. 30 is a flowchart illustrating market health process 25 steps, according to an embodiment of the present invention showing inputs and outputs.

FIG. 31 is a flowchart illustrating individual & organizational reports & summaries process 26 steps, according to an embodiment of the present invention showing inputs and outputs.

FIG. 32 is a flowchart illustrating change control process 27 steps, according to an embodiment of the present invention showing inputs and outputs.

FIG. 33 is a flowchart illustrating configuration management process 28 steps, according to an embodiment of the present invention showing inputs and outputs.

FIG. 34 illustrates example commercial equivalent cost tables for individuals and resources and performance factors definitions, according to an embodiment of the present invention.

FIG. 35 illustrates example total value and market value calculations for individuals, according to an embodiment of the present invention.

FIG. 36 illustrates example total value and market value calculations for resources and capabilities, according to an embodiment of the present invention.

FIG. 37 illustrates example scorecard metrics, according to an embodiment of the present invention.

FIG. 38 illustrates example definitions for scorecards, according to an embodiment of the present invention.

### DETAILED DESCRIPTION OF THE INVENTION

The present invention applies e-commerce practices to create an e-management market designed to meet the management needs of an organization or community. The e-management market is designed to replace existing business management practices, and provides a direct solution provider to requirement link. This description provides an end-to-end process that covers then entire lifecycle of the e-management market. The following description will use the terms “e-management market” and “market”. In this description these terms are interchangeable and are referring to the same structure that describes a web-enabled network location designed and developed to replace or augment management functionality. Other important terms: a “requestor” is a decision-making individual who has legal authority to make a request and accept a proposal during a transaction. A “responder” is a potential solution provider who provides a proposal to meet a requirement, and must be able to legally represent the proposed response and resources. The e-management market doesn't replace organizational or community policies, regulations, or rules of engagement.

Method Overview

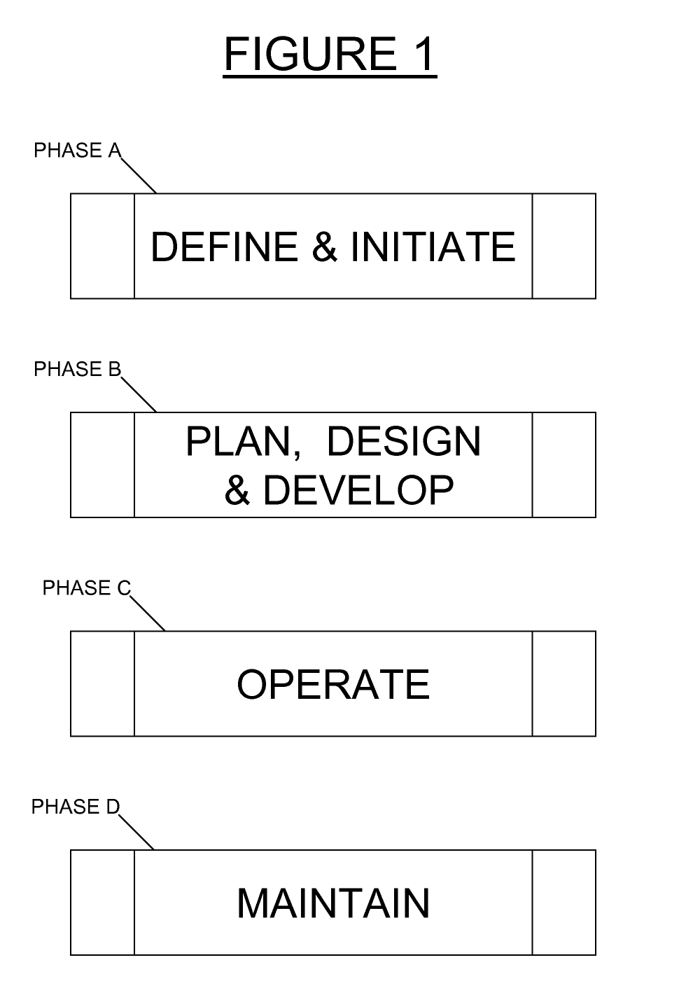

FIG. 1 illustrates an overview of a method for developing, operating, and maintaining an e-management market, in accordance with an embodiment of the invention. In life-cycle phase A an e-management market is defined and initiated. In phase B the e-management market is planned, designed, developed, and implemented. In phase C the e-management market is used operationally. In phase D life-cycle maintenance activities are accomplished.

Define & Initiate Phase

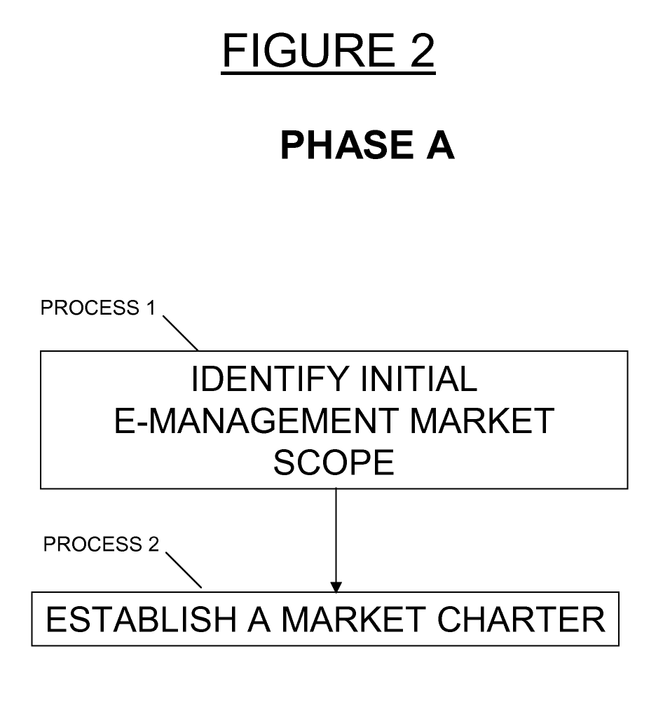

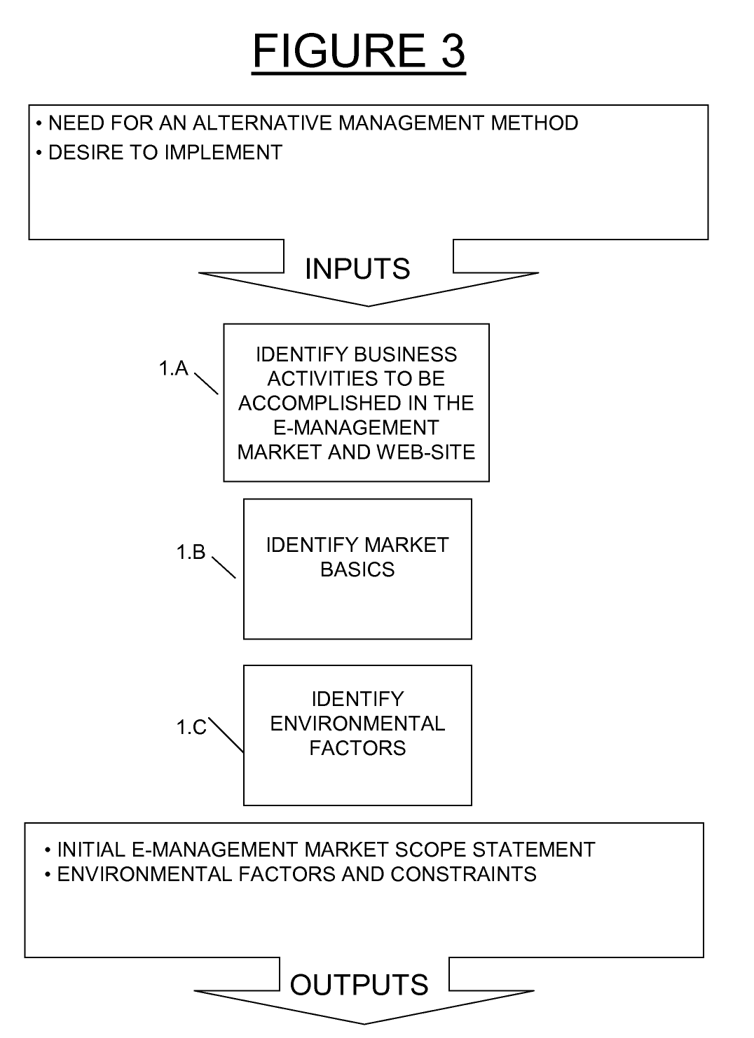

FIG. 2 is a flowchart illustrating define and initiate phase A, according to an embodiment of the present invention. Two processes are included in this phase. FIG. 3 is a flowchart illustrating initial e-management market scope process 1 steps, according to an embodiment of the present invention showing inputs and outputs. The figure illustrates the inputs and outputs for the process. E-management markets are developed based on a recognized need to improve existing business activities to achieve the efficacies of today's technology. Such a need was evident following the events of Hurricane Katrina. Our federal government needs to change the processes used in disaster management, coordination, and response to achieve effective results. In step 1.A the business activities to be accomplished in the e-management market and web-site are identified. Examples of these activities include but are not limited to: information sharing, collaboration, personnel task assignment, course of action analysis and selection, project tasking, capability gap-analysis, planning and resource management.

In step 1.B market basics and essentials are identified. Transactions are the basic activity for e-management markets; demand is met with supply. E-commerce market principles translate to the basics of an e-management transaction as follows: what is needed (demand); who or what can meet needs (supply); how to record a transaction value; and identify participation incentive. An example value method captures all resources reflected in a transaction and applies commercial costs against those results. A non-monetary value method may substitute a currency exchange during market transactions to make the market strategy work and is explained later in advanced market functions.

Since most e-management market transactions do not involve currency, careful thought must be given to characterizing the value of the transaction to employ an effective market strategy. For example, in a disaster relief market, a complete summary of the resources or services (including man-hours) used in each transaction is important. This transaction record is important because disaster responders are often programmed assets (paid for resources, personnel, and capabilities) such as Police, Fire Department, National Guard, etc. By recording programmed asset demand and use during a disaster event or planning session, measures of value for these programmed resources may be determined, providing more than sufficient incentive for participation.

Other examples of participation incentives include using recorded market results in performance reports, award criteria, published rankings, and to determine organizational budget and manning for future years. For information or knowledge exchanges, participation must matter in some way so that participation is encouraged to replace the “profit motivation” of commercial markets. This may be accomplished by tying market performance to measures used in career evaluations and awards. A published ranking system may have an equally effective result, especially for exchanges between organizations. For resources or capabilities, market results may be used in return on investment analysis. For example, when considering the utility of an expensive intelligence satellite asset, decision-makers may ask how many products or services were provided to the market and how often was the satellite used in key decision making? Market basics are the essential enablers of an e-management market strategy: supply; demand; value basis for the transaction; and motivation to complete transactions. Once market basics are identified for the business activities, an e-management market may be designed and developed. In step 1.C organizational or community environmental factors are identified. Examples of these factors include but are not limited to regulatory issues, organizational policies, privacy and intellectual property constraints, and common network availability. Participation in the e-management market works within these environmental factors.

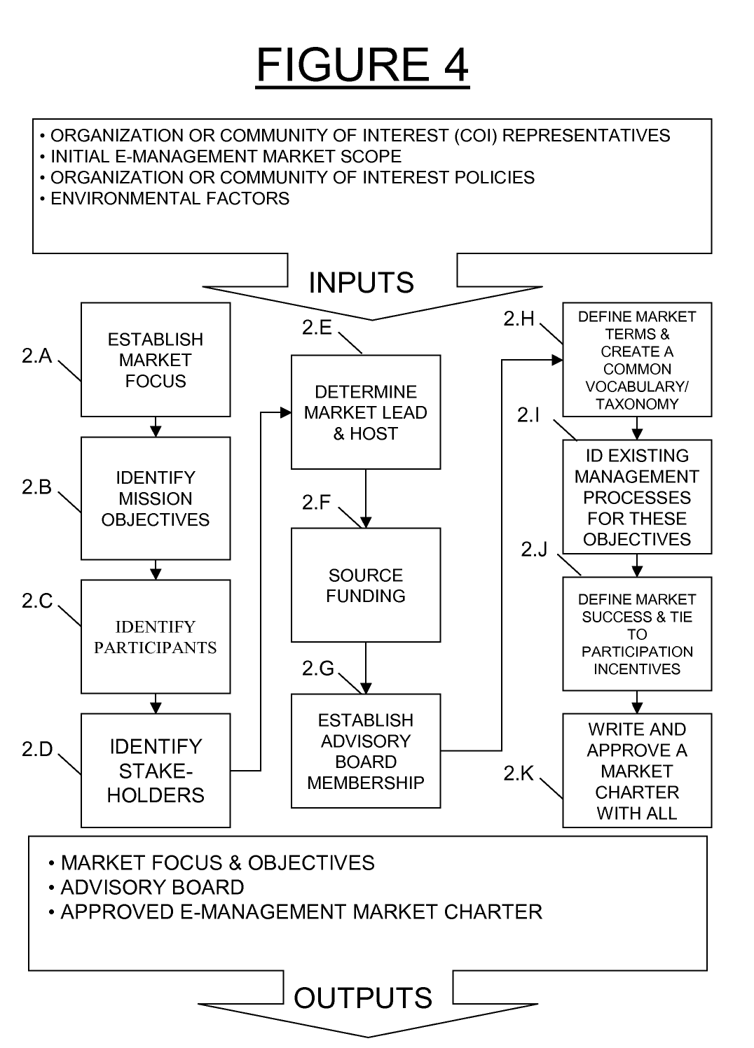

FIG. 4 is a flowchart illustrating market charter process 2 steps, according to an embodiment of the present invention showing inputs and outputs. A market charter is a formal declaration of e-management scope, objectives, and focus agreed to by an organization or community. In step 2.A e-management market focus is established. The focus or mission defines the purpose for the e-management market and encompasses the shared goals of organizational or community participants. Some examples of e-management market focus are: intelligence, information or knowledge sharing; disaster planning or response; task assignment; and community governance. In step 2.B e-management market mission objectives are identified. Mission objectives are overall measurable results related to the operation of an e-management market and tied to the focus. Example of mission objectives are: increase speed to solution, better coordination, increased information and knowledge sharing. In step 2.C organizational or community market participants are identified. A market participant is a person or organization that takes part in e-management market transactions. In step 2.D market stakeholders are identified. A stakeholder is a person or organization that is actively involved in the market, or whose interest may be affected by the operation of the e-management market. Stakeholders may exert some influence over the e-management market. In step 2.E an organization or other entity is designated as the lead for the e-management market and the host network location for the market is established.

In step 2.F e-management development funding as well as operation and maintenance funding sources are identified. In step 2.G an advisory board and its membership is established. In step 2.H a taxonomy, common vocabulary, and definition of specific terms are established for the e-management market. In step 2.1 the existing business process that are used to accomplish the objectives stated for this embodiment are identified so that measures of improvement over the old methods may be established. In step 2.J e-management market success is defined. Market success will likely have a direct relationship to measures of improvement over existing management methods and relate to the shared goals and objectives of the e-management market. In general the number of successful market transactions is a bench mark statistic indicating market health. Thus incentives to encourage participation and the successful completion of transactions are essential and tie individual and organizational success to market success. Like its commercial equivalent, if the e-management market is doing well, participants should do well. In step 2.K all of the subject matter captured by these steps and any other information deemed necessary for this e-management market is written as a market charter and approved by the organization or community. With these define an initiate processes and steps complete, the plan, design, and develop phase may begin.

Plan, Design, & Development Phase

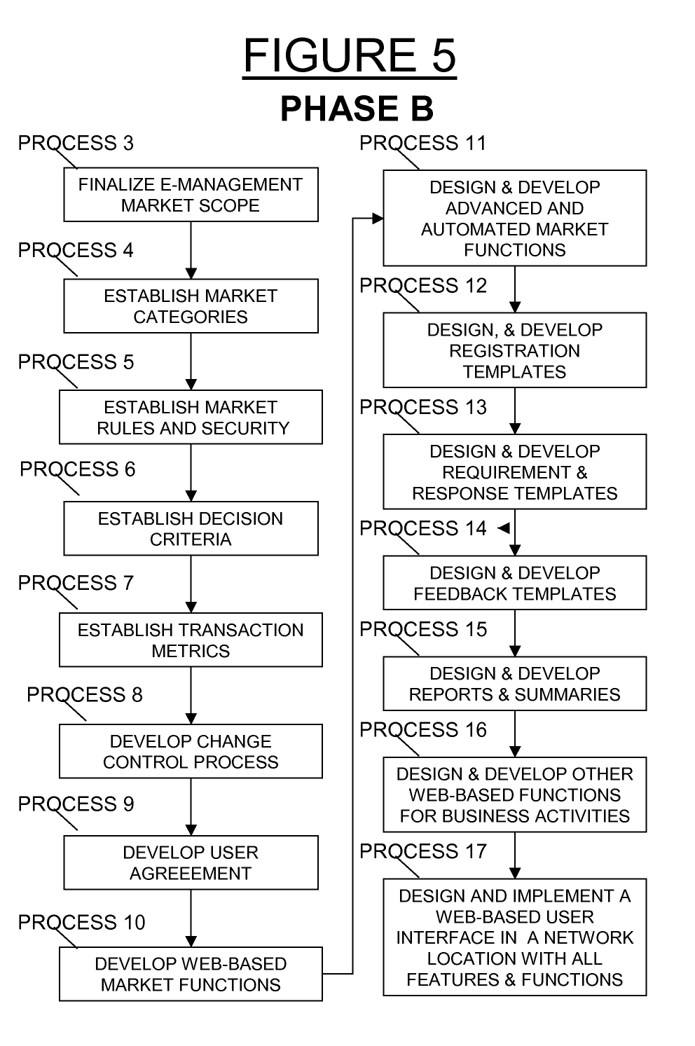

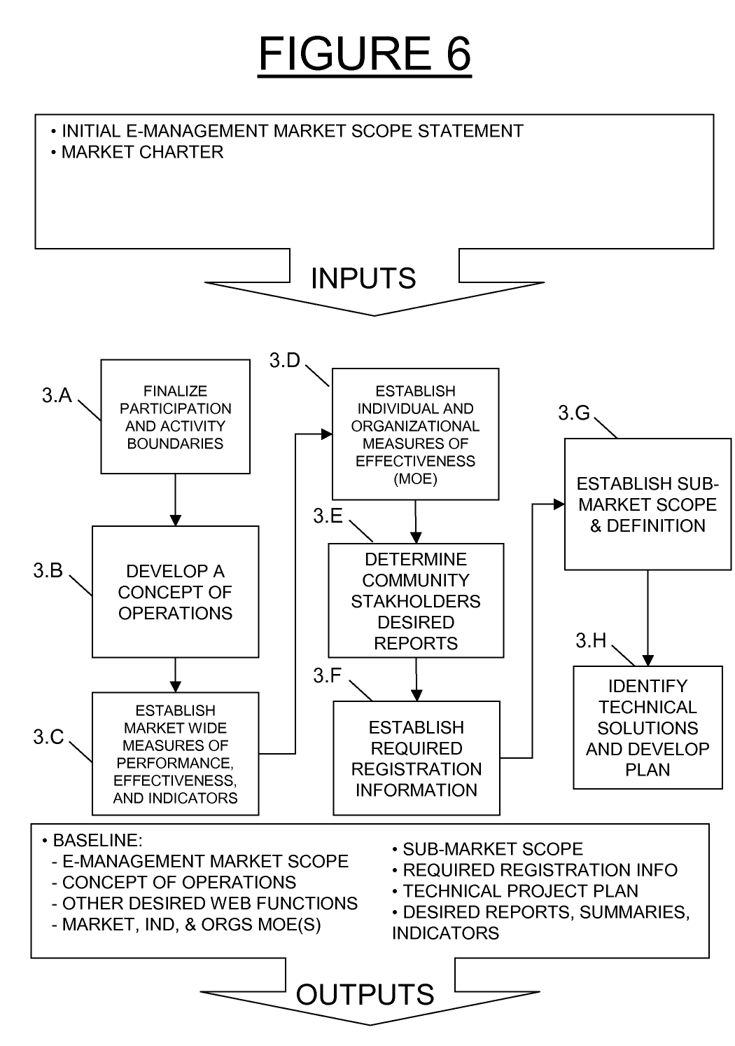

FIG. 5 is a flowchart illustrating plan, design, and develop phase B, according to an embodiment of the present invention. This phase has 15 processes. FIG. 6 is a flowchart illustrating final e-management market scope process 3 steps, according to an embodiment of the present invention showing inputs and outputs. In step 3.A the initial e-management market business activities and participation are finalized. These become the e-management market boundaries and provide a clear market purpose. In step 3.B a concept of operation (CONOP) is established that illustrates the use of the e-management market for the specific community's defined business processes. The CONOP envisions participant transactions, access methods, e-management market location, and defines how this e-management market will operate. Other desired web-functions are identified here to complete the needs of the desired business activities. In step 3.C market-wide measures of performance, effectiveness, and indicators are established based on the community objectives identified in step 2.B. In step 3.D individual and organizational measures of effectiveness are established. The measures of effectiveness established in step 3.C and 3.D are used in the reports desired by participants and stakeholders.

In step 3.E the e-management market community stakeholders, participants, and advisory board are surveyed to determine the initial reports, summaries, and indicators to be developed. Example reports and summaries include: number of requirements by category, requirements without proposals, by organization, individual; number of successful transactions; summary feedback scores and reports by individual, organization, or category; ranked listing of organizations, individuals, capabilities, etc by number of successful transactions or market value. Some example indicators include: number of unmet requirements; comparison of the rate of new requirements to the rate of completed transaction; total number of open requirements. An advanced market summary is a social network analysis of all transactions showing the connections and relationships. Another advanced market report provides a portfolio analysis of a selected resource by market performance and value. Most basic reports and summaries for markets involve calculations based on supply and demand that are shown by market transactions. In step 3.F required registration information is established. This is the information that the e-management market will capture about individuals, organizations, and/or capabilities as they are registered on the site. In step 3.G sub-market scope and definitions are established. Sub-markets may be defined by common criteria where a focused sub-activity is accomplished. For example in a disaster response market, sub-markets may be established by event, for planning purposes, or by location. In step 3.H technical solutions and developers are identified and selected. Activities in this step include capturing technical solution proposals, selecting a technical developer, and developing the technical project plan.

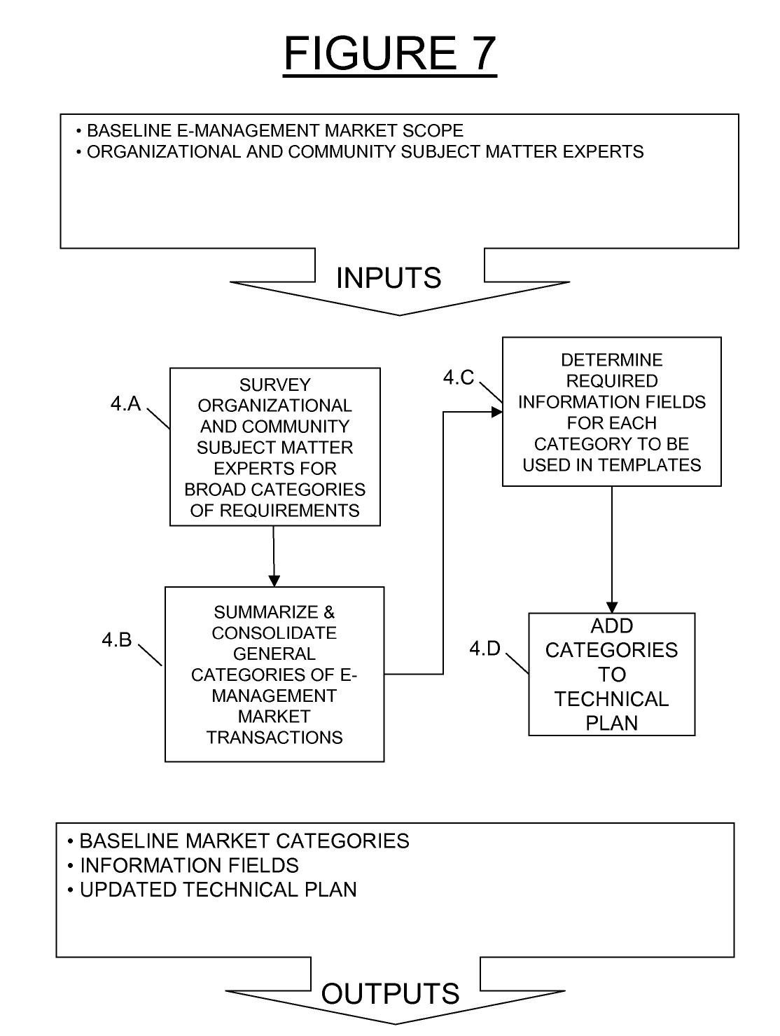

FIG. 7 is a flowchart illustrating market categories process 4, according to an embodiment of the present invention showing inputs and outputs. In step 4.A the community subject matter experts are surveyed to capture broad categories of market requirements, essential information fields to describe those requirements, and identify value measures to capture during transactions. Market categories provide a method of transaction organization and broadly reflect market demand. In step 4.B the survey inputs are summarized into a list of initial e-management market categories. In step 4.C the survey results are summarized into a list of essential information needed to describe a category requirement and value for each of these categories. This essential information is captured in fields during e-management market transactions. In step 4.D these categories and essential information fields are added to the technical plan. Some examples of categories in a disaster market are: command and control, fire response, general aid, logistics, medical, police, security, rescue and recovery, and technical support. For each category, separate fields and values are established.

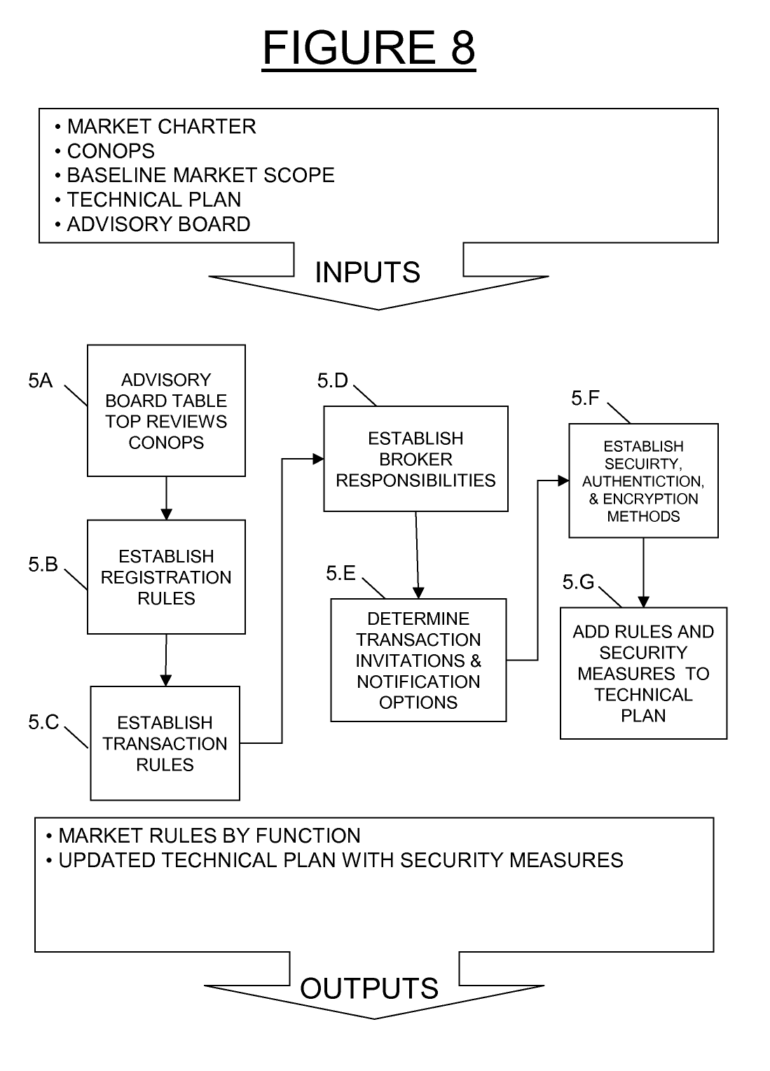

FIG. 8 is a flowchart illustrating market rules and security process 5, according to an embodiment of the present invention showing inputs and outputs. In this process rules and security are established for e-management market functions. In step 5.A the advisory board completes a table-top discussion based on the market functions illustrated in the CONOP to identify the need for market rules and security methods. During this review all transaction functions are identified that require special market rules, security, as well as broker roles and responsibilities. In step 5.B registration rules are established. Who may register and participate in the market is based on those participants identified in step 2.C. For example, a disaster response market is not open to the public and only those invited may register and participate. In step 5.C transaction rules and options are established. For example is a disaster response market it is important to depict a requirement priority. Priorities have definitions and a market rule may require that a notification is sent out by the selection of certain priorities. In step 5.D broker roles and responsibilities are established; these are organizational or market-wide roles. For example, in the disaster response scenario mentioned in step 5.C, if a priority one is selected by the requirement poster, by rule a subject matter expert broker may be required to validate the priority of the requirement. In general, market or organizational brokers are responsible for increasing the number of successful e-management market transactions. These roles and activities are recorded during transactions and can be used to calculate broker effort values. In step 5.E transaction invitations and notification options are determined. In step 5.F e-management market security measures, identification and authentication, and encryption methods are established. These may include measures for market access, data and information security, and authentication of transaction participants. In step 5.G all determined rules and security measures are added to technical plan.

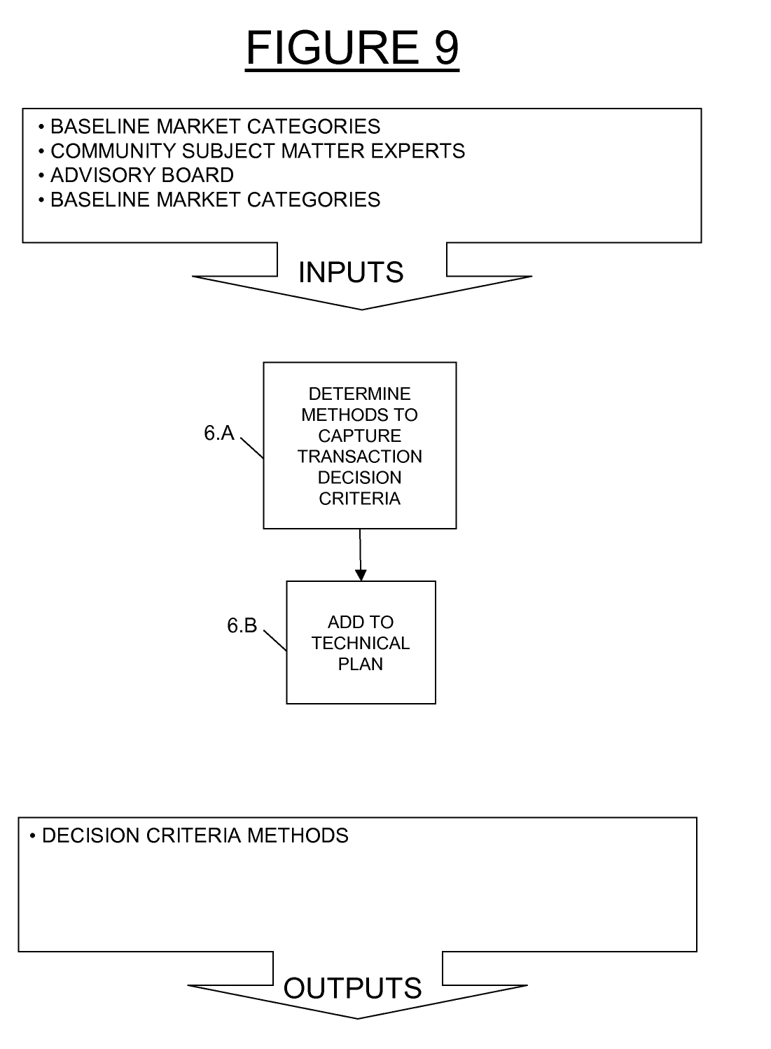

FIG. 9 is a flowchart illustrating decision criteria process 6, according to an embodiment of the present invention showing inputs and outputs. In step 6.A the methods for capturing transaction decision criteria are determined. Decision criteria are a documented set of factors that are used to compare proposed solutions by value, risks, and benefits by the requestor. A basic method of capturing decision criteria is by creating text descriptions of the criteria in a requirement template with a request to address them in the text of a response template. Examples of other methods involve providing decision criteria with decision-maker weighted value in normalized fields, capturing a list of constraints, and providing direct links to related responder history on responses. These decision criteria methods may differ by requirement. In step 6.B the decision criteria methods are added to the technical plan.

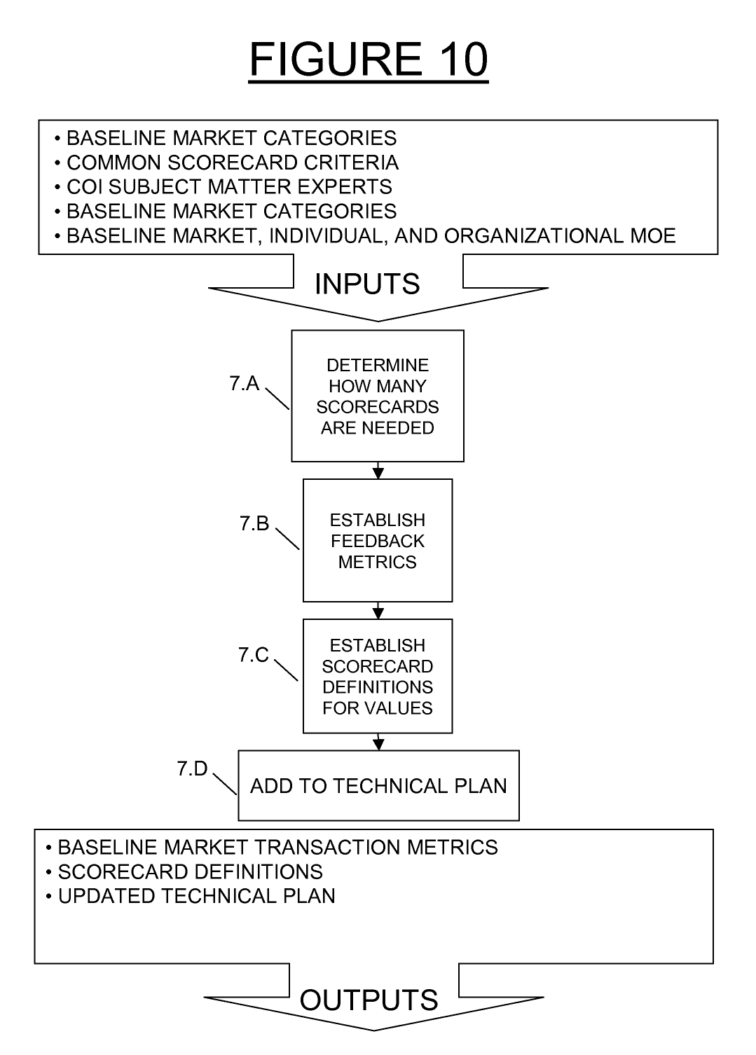

FIG. 10 is a flowchart illustrating transaction metrics process 7, according to an embodiment of the present invention showing inputs and outputs. In step 7.A the number of scorecards needed by the e-management market is determined. Scorecards are used to describe measures of transaction success in feedback exchanges. The scorecards provide common objective criteria and definitions for each scored value. Scorecards may be generic for the entire e-management market or built to reflect transaction categories. The number of different scorecards needed in the e-management market is reflective of market scope. For example, information exchanges are often scored very differently than logistics exchanges. In step 7.B feedback metrics are established. Metrics captured at the transaction level often relate and feed into to market measures of effectiveness. Careful thought must be given to developing the metrics captured on each transaction so that community concerns may be monitored. Metrics are defined on both sides of the transaction for both the responder and requestor. This step answers the question “what should be measured about the transaction?” As an advanced feature, decision-making requestors may be allowed to define one or two metrics of their own, in addition to standard market measures, allowing the decision-makers the ability to score and provide feedback on performance criteria they find important.

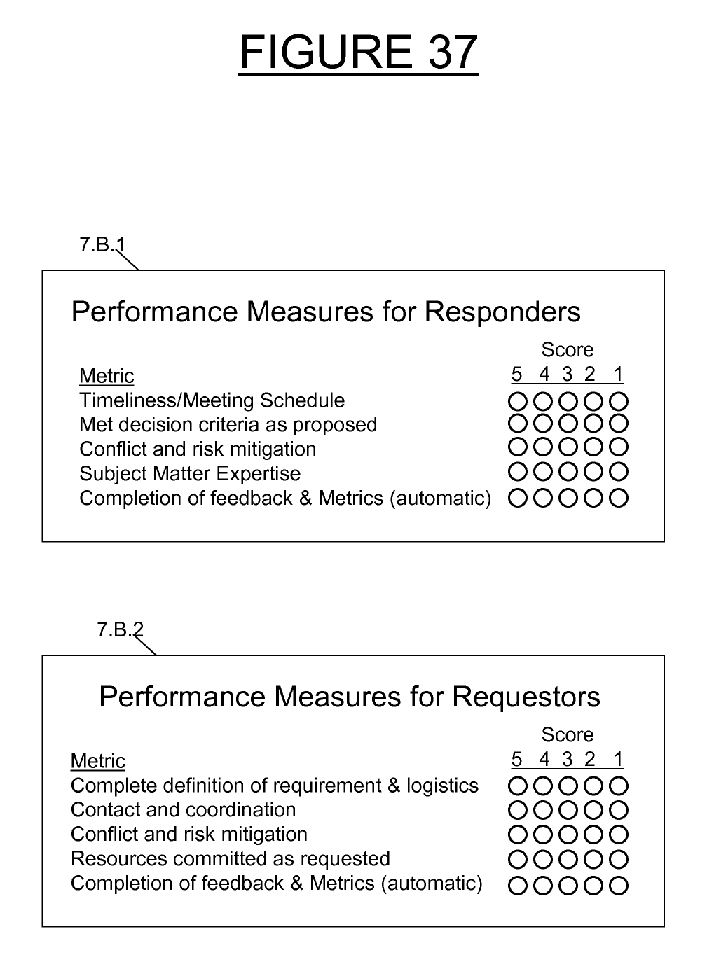

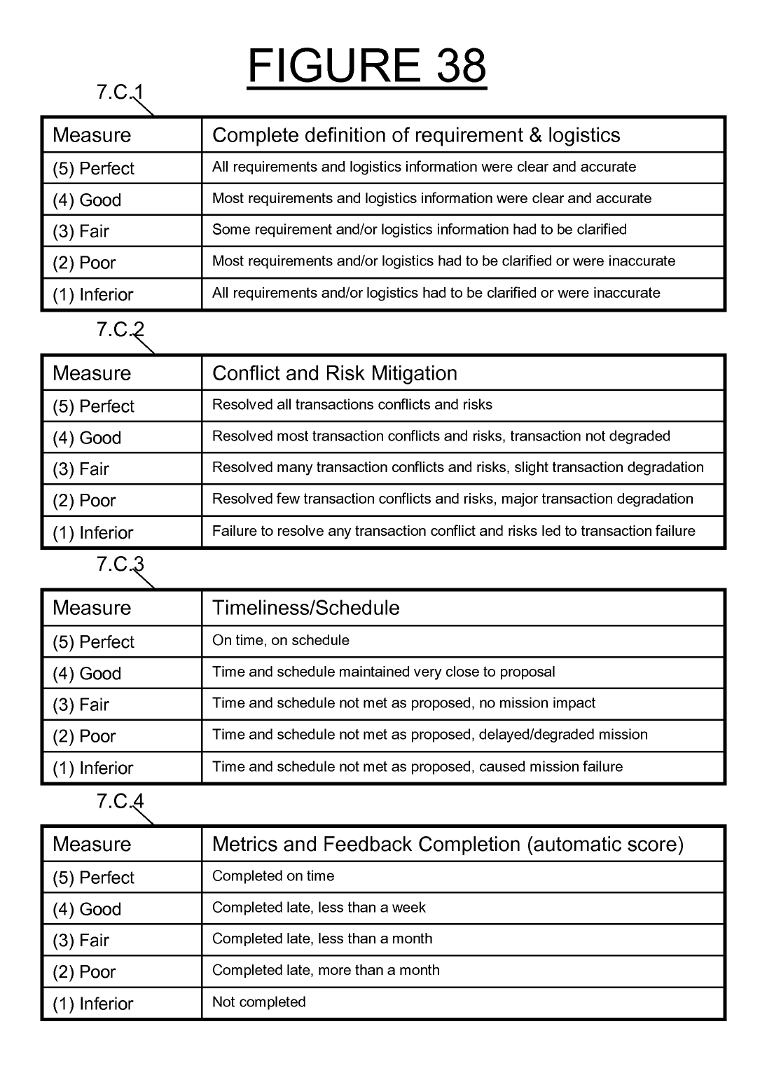

FIG. 37 illustrates example scorecard metrics, according to an embodiment of the present invention, a responder scorecard is illustrated in 7.B.1 and a requester scorecard is shown in 7.B.2. In step 7.C scorecard metric values are defined. FIG. 38 illustrates example definitions for scorecards, according to an embodiment of the present invention. 7.C.1 7.C.2, and 7.C.4 are metric definitions for requesters. 7.C.2, 7.C.3, and 7.C.4 are metric definitions for responders. 7.C.4 is a metric that is automatically scored when the feedback is completed based on a market rule (mandatory feedback) and established as an automatic market function in process 11. If the decision making requester is allowed to create feedback metrics of their own, they must also provide these definitional scorecards and provide those with the requirement for responder review. In step 7.D feedback scorecards are added to the technical plan. Historical market feedback metrics and scorecards achieve trust and confidence that a decision-maker needs to evaluate proposed personnel, resources, and capabilities. These are essential enablers to establish a replace stovepiped decision-making.

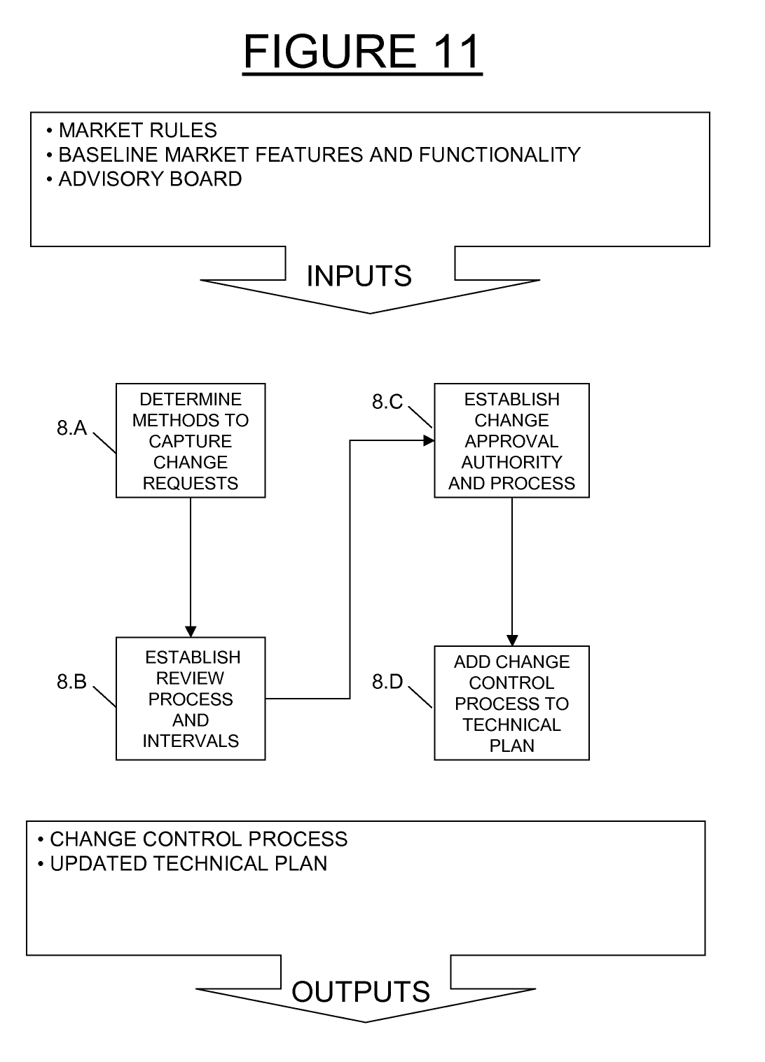

FIG. 11 is a flowchart illustrating change control process 8 steps, according to an embodiment of the present invention showing inputs and outputs. In step 8.A methods to capture e-management market change requests are determined. In step 8.B a review process is established with scheduled intervals. In step 8.C an e-Management market change approval authority and process is established. Options include approval by the advisory board or vote by the community members. In step 8.D the change control process is added to the technical plan.

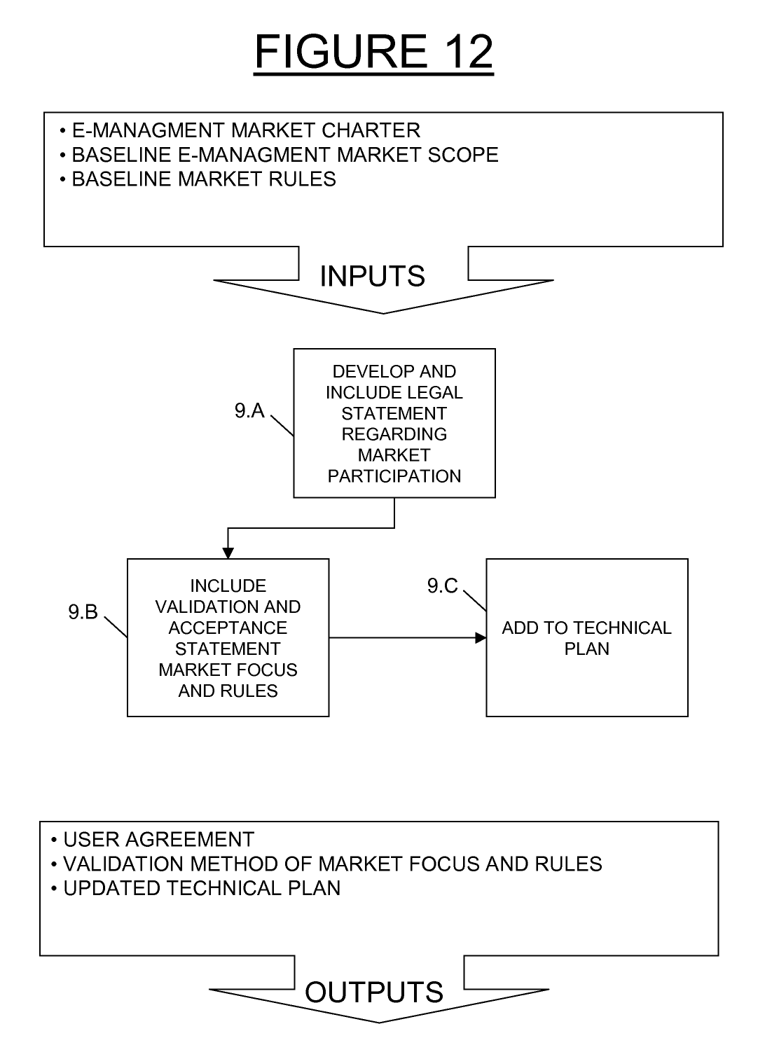

FIG. 12 is a flowchart illustrating user agreement process 9 steps, according to an embodiment of the present invention showing inputs and outputs. In step 9.A a user agreement is drafted with a legal statement regarding participation in the e-management market. In step 9.B a statement of validation and acceptance of market focus and market rules is included in the user agreement. The user agreement is a validation and acceptance method for the e-management market. In step 9.C the user agreement is added to the technical plan.

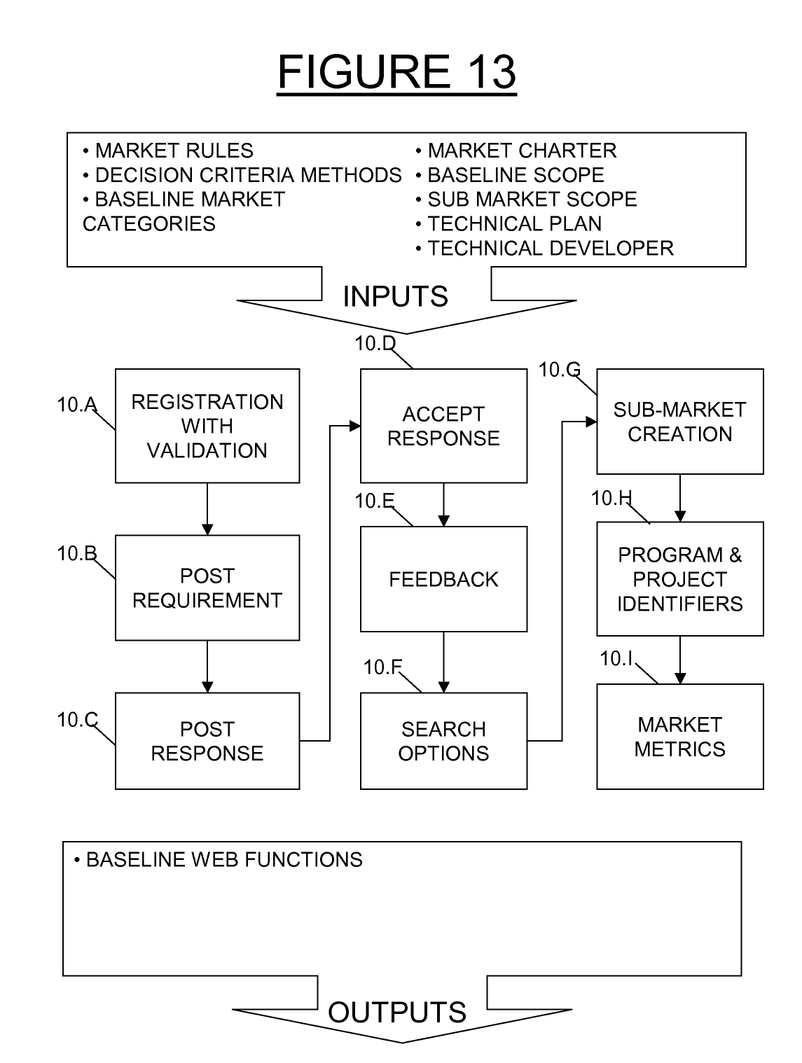

FIG. 13 is a flowchart illustrating web-based market functions process 10 steps, according to an embodiment of the present invention showing inputs and outputs. In step 10A an e-management market registration and validation function is developed technically. In step 10B a post requirement function is developed technically. In step 10.C a post response function is developed technically. In step 10.D an accept response function is developed technically. In step 10.E a feedback function is developed technically. In step 10.F search options are developed technically. In step 10.G a sub-market creation process is developed technically. In step 10.H program, project, and funding identifiers are developed technically. In step 10.1 indicators and metrics are developed technically. Metrics are a specified summary of transactions, and reflect organization or community measures of performance. Metric and indicator links to what is measured must be established early and links to those measures known. Metrics and indicators are the input for reports and summaries.

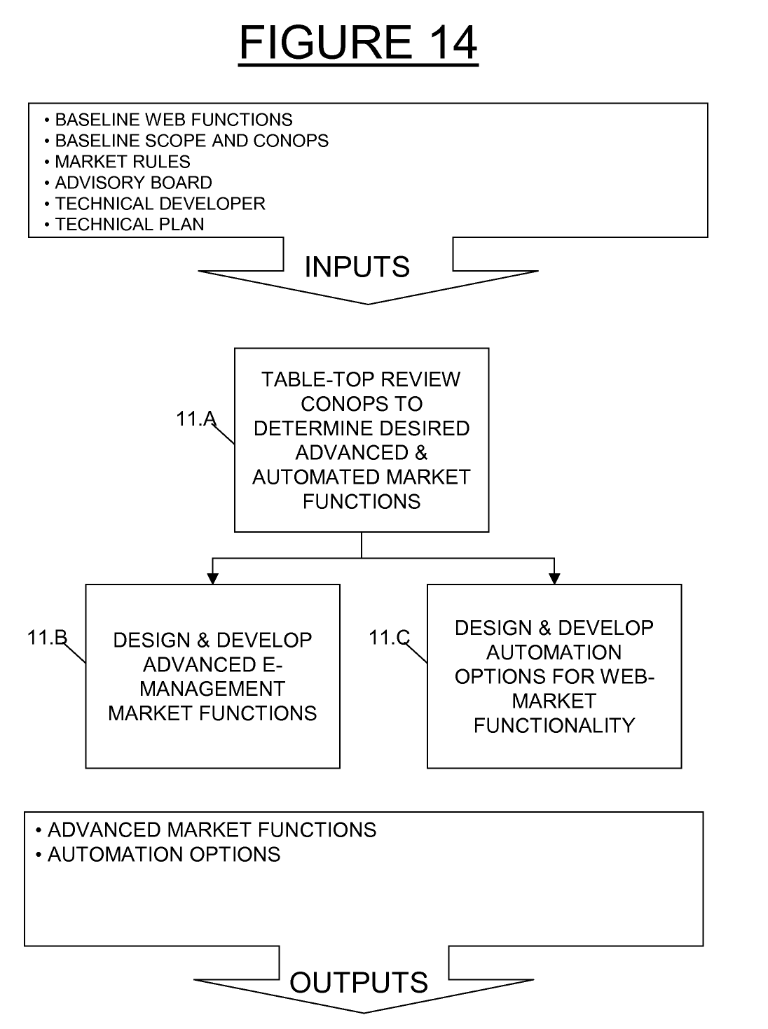

FIG. 14 is a flowchart illustrating advanced and automated market functions process 11 steps, according to an embodiment of the present invention showing inputs and outputs. In step 11.A the CONOPS is reviewed by the advisory board and COI subject matter experts to identify desired advanced e-management market functions and automation options. Some example advanced features include subscription services, transaction and activity counts, market value calculations, social network analysis methods linked to transactions, portfolio analysis methods, and requester metric definition. Subscription services allow participants to sign up for automatic access to authoritative data sources. Subscriptions have a published value for the subscribed time period and periodic feedback is required to maintain a performance record. These sources may be associated with the content available within the e-management market, or they may be located in a separate authoritative data store and only managed from the market space. Automatic value calculations can be attained by establishing common cost resource tables. Commercial cost equivalents or lifecycle return on investment measures would be used in conjunction with the number of resources represented in the transaction to determine a basic cost of the transaction. This information combined with feedback results and level of demand can establish a market “price” or value.

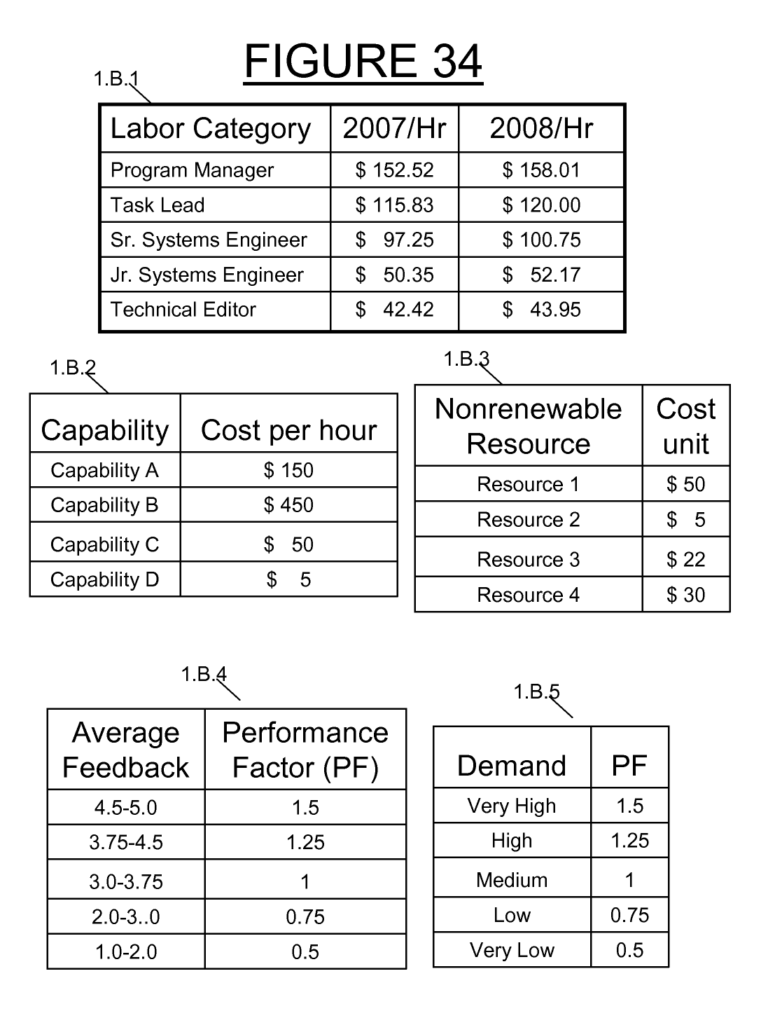

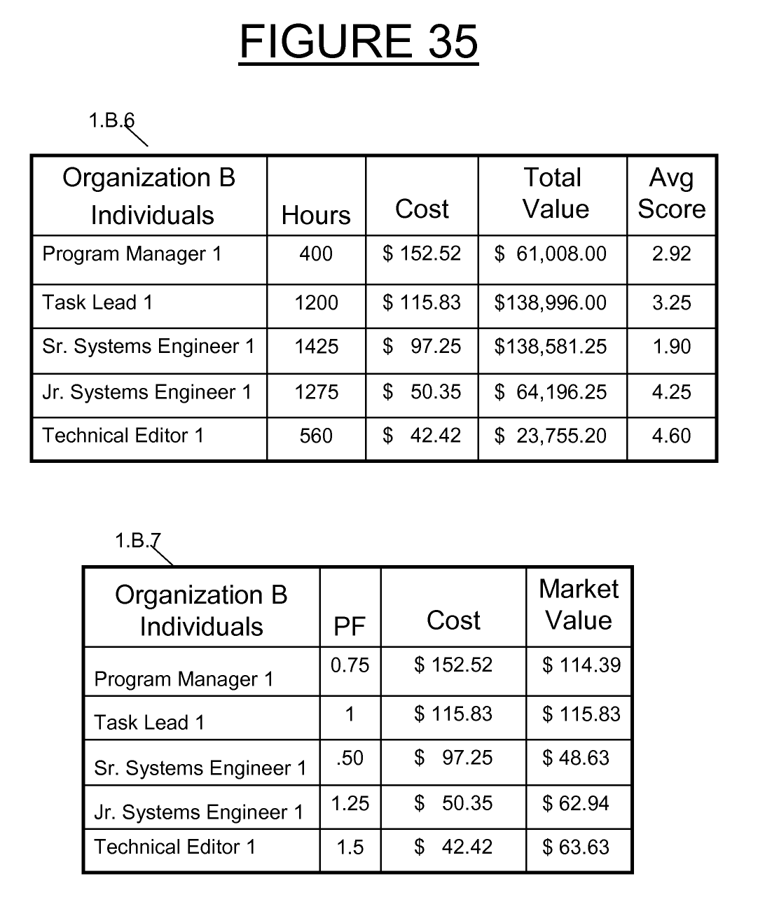

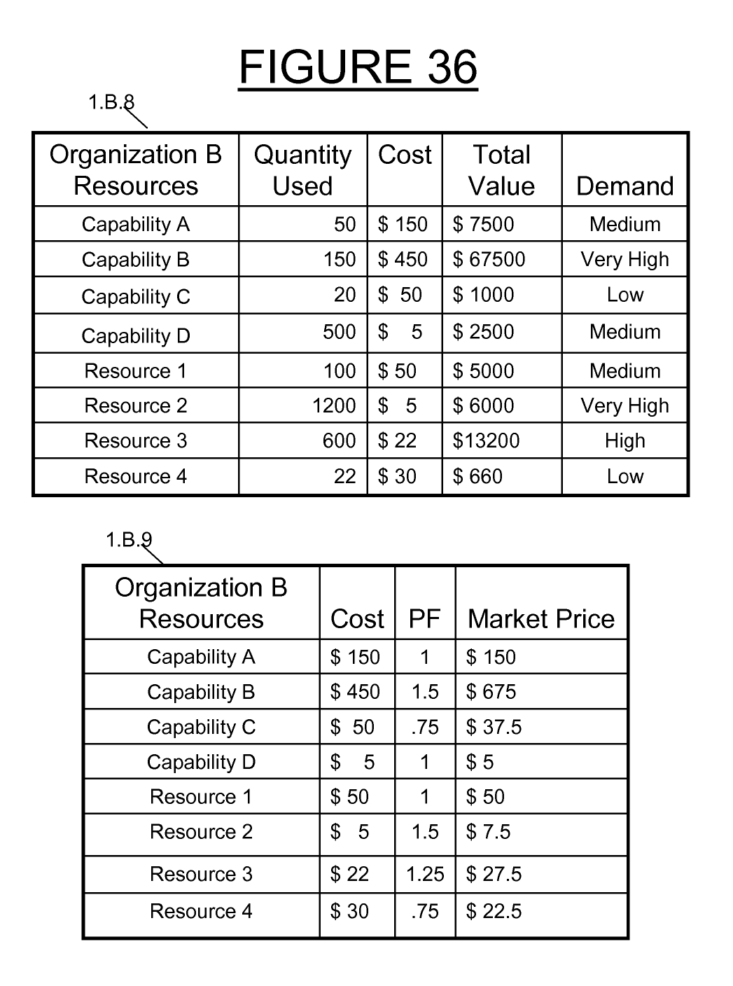

A total value and market value calculation is demonstrated in FIG. 34 through FIG. 36. FIG. 34 illustrates example commercial equivalent cost tables for individuals and resources and performance factor definitions, according to an embodiment of the present invention. l.B.1 shows commercial labor category cost per hour. 1.B.2 shows commercial equivalent capability costs, capabilities are generally reusable resources or combinations of resources and personnel. 1.B.3 show commercial equivalent resource costs, these are supplies and other nonrenewable resources. FIG. 35 illustrates example total value and market value calculations for individuals, according to an embodiment of the present invention. Both total and market value calculations provide competitive measures of market performance and help achieve a market strategy. Table 1.B.6 calculations use total hours used in transactions for a defined period of time and applies the cost for those hours from table l.B.1 to determine the total value applied to the market by individuals. The average feedback score is recorded in the e-management market and is also displayed in table 1.B.6. 1.B.7 displays the calculation for market value by taking the commercial cost and applying a performance factor based on feedback scores from table 1.B.4. FIG. 36 illustrates example total value and market value calculations for resources and capabilities, according to an embodiment of the present invention. Table 1.B.8 calculations use total hours or total number of resources used in transactions for a defined period of time and apply the cost for those capabilities or resources from tables 1.B.2 and 1.B.3 to determine the total value that was applied to the market by resources and capabilities. Resource and capability demand, as shown in market transaction statistics, calculated by the e-management market and is also displayed in table 1.B.8. l.B.9 displays market value calculation by taking the commercial cost and applying a performance factor based on demand scores from table 1.B.5. These market value calculations provide a performance analysis based on cost, in other words is a resource outperforming its cost or underperforming its cost?

Some examples of automation options include capacity and availability calculations; automatic feedback submission scores, solution discovery, and sense and respond logistics. Capacity can be automatically tracked by the market against registered market resources by applying committed transaction resources against available capacity for a time period. Availability of market resources can be automatically tracked using similar methods. Discovery query methods may be designed to search market profiles. Sense and respond methods involve automating decision-making especially for low risk logistic needs. This method will automatically complete a transaction when the requirement is presented to the market with the first available resource that meets the decision criteria. In step 11.B identified advanced e-management market functions are designed and developed. In step 11.C automation options are designed and developed.

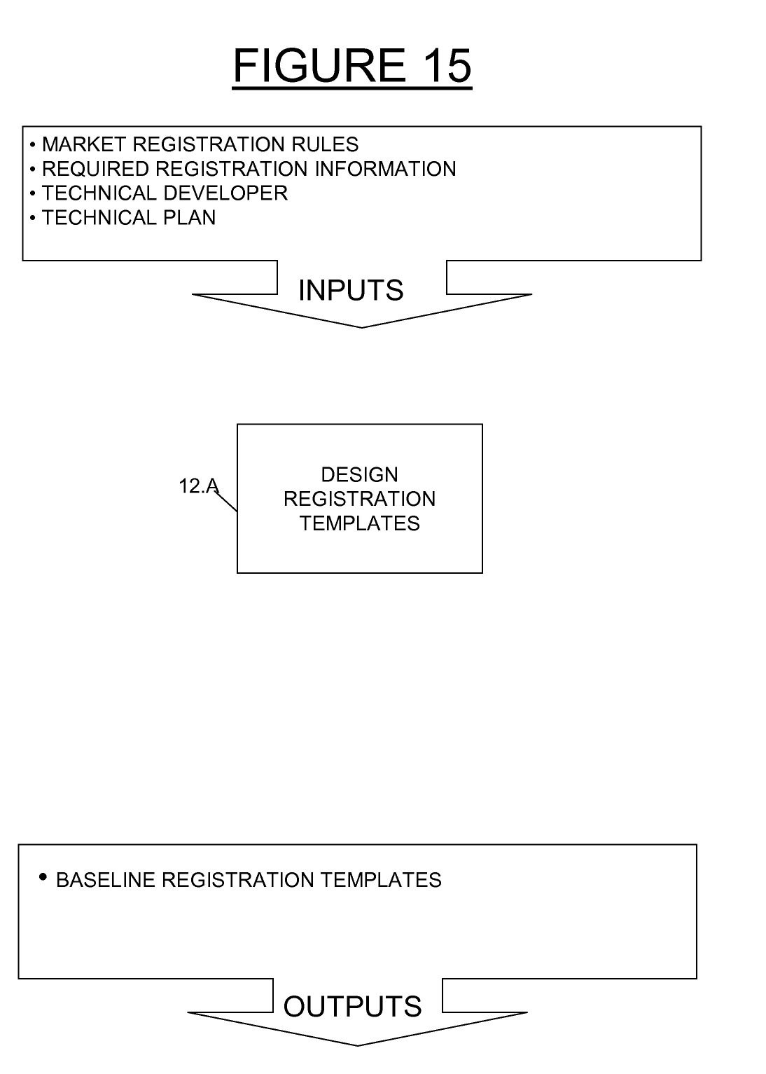

FIG. 15 is a flowchart illustrating registration templates process 12 steps, according to an embodiment of the present invention showing inputs and outputs. In step 12.A registration templates are designed and developed. Field choices are made based on previously determined required registration information. Structured data fields such as pick lists and other normalized fields are used on the e-management market registration templates. Unstructured data fields such as text descriptions are also used. Several types of registration templates are required for the e-management market, depending on what is being registered. Templates are needed for organizations, individuals, and capabilities. Other registration templates are needed for project, program, or funding codes if these are used in the e-management market.

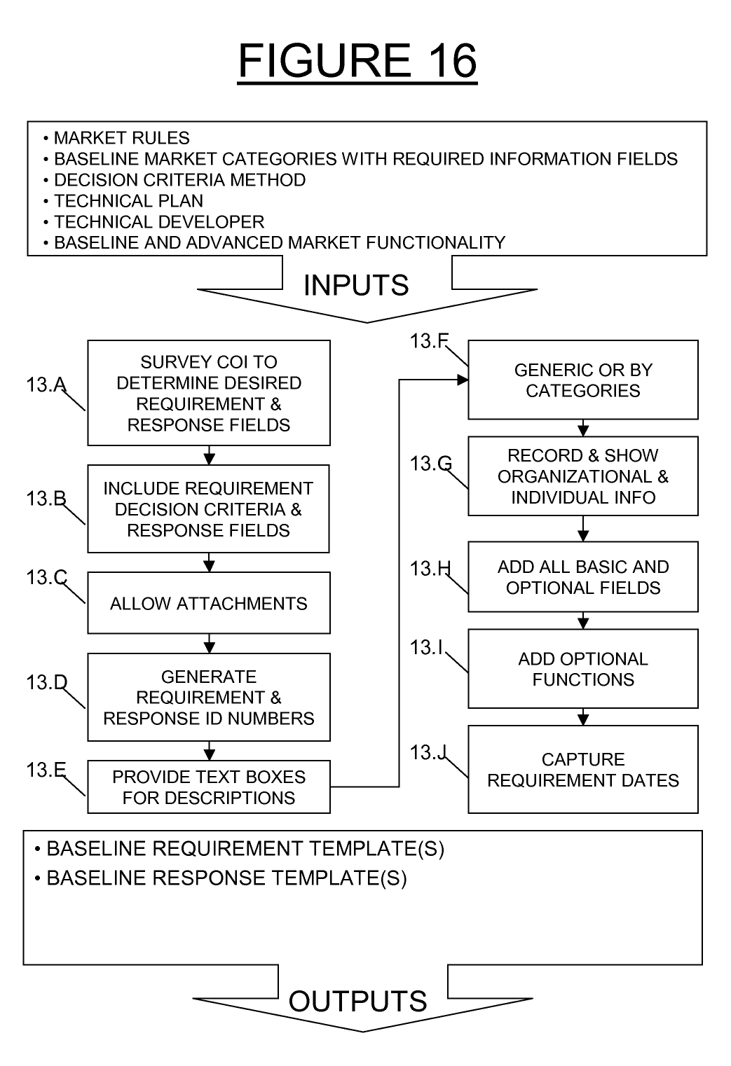

FIG. 16 is a flowchart illustrating requirement and response templates process 13 steps, according to an embodiment of the present invention showing inputs and outputs. In step 13.A the advisory board and community subject matter experts are surveyed to develop a list of desired requirement and response template fields and functions. These fields are added to the templates as structured and unstructured fields. Basic fields include title, category, sub-market, and priority. Likely required template functions include unique identification number generation, notifications, save, submit, and broker roles. In step 13.B the requirement decision criteria and response fields are added to the templates. In step 13.C attachment fields are added to the templates. In step 13.D an identification number generation method is added to the e-management market requirement and response templates. In step 13.E unstructured text description fields are added as requested. In step 13.F additional requirement and response templates are developed by category as requested. In step 13.G organizational and individual information is added to the templates as requested. In step 13.H basic and optional fields are added to the templates as requested. Optional fields include project, program, or funding identification numbers. In step 13.1 optional functions are added to the templates. These optional functions may include notifications, invitations, save without submit, copy to new requirement, and or visibility options on requirements or response proposals. In step 13.J date fields are added to the templates. Date fields examples include the date submitted, the date proposal responses are due, requested delivery date, and proposed delivery date.

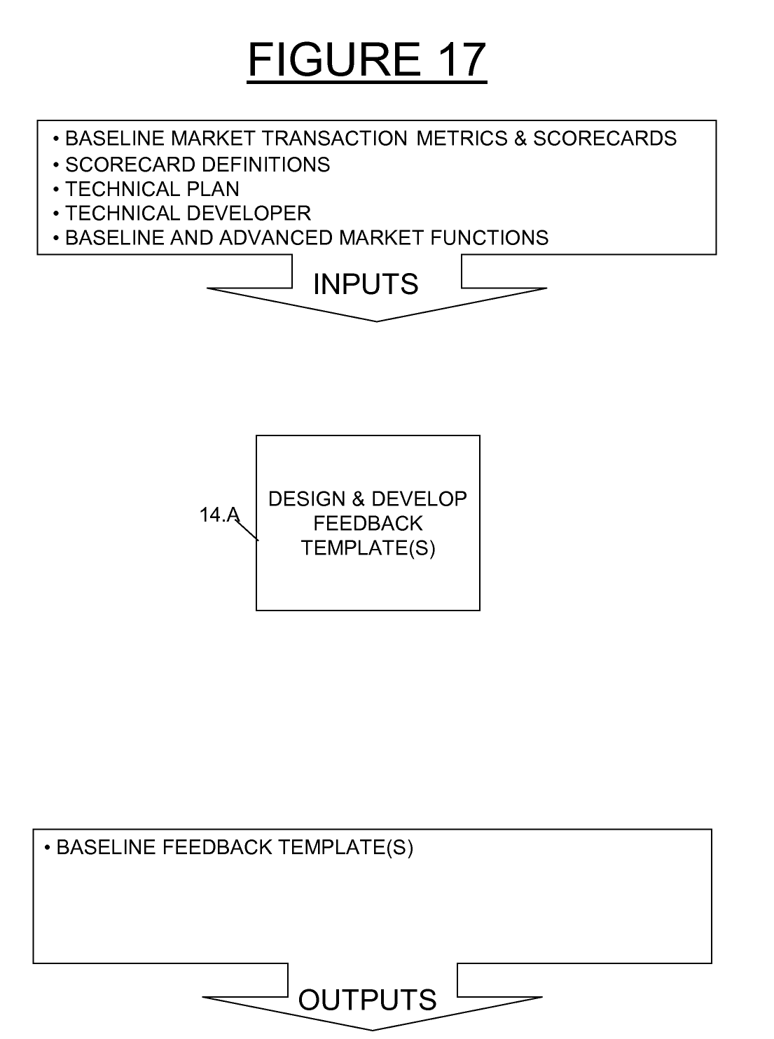

FIG. 17 is a flowchart illustrating feedback templates process 14 steps, according to an embodiment of the present invention showing inputs and outputs. In step 14.A the e-management market feedback templates are designed and developed for both sides of the transaction for requester and responder. Scorecards and definitions developed in process 7 are added to these templates.

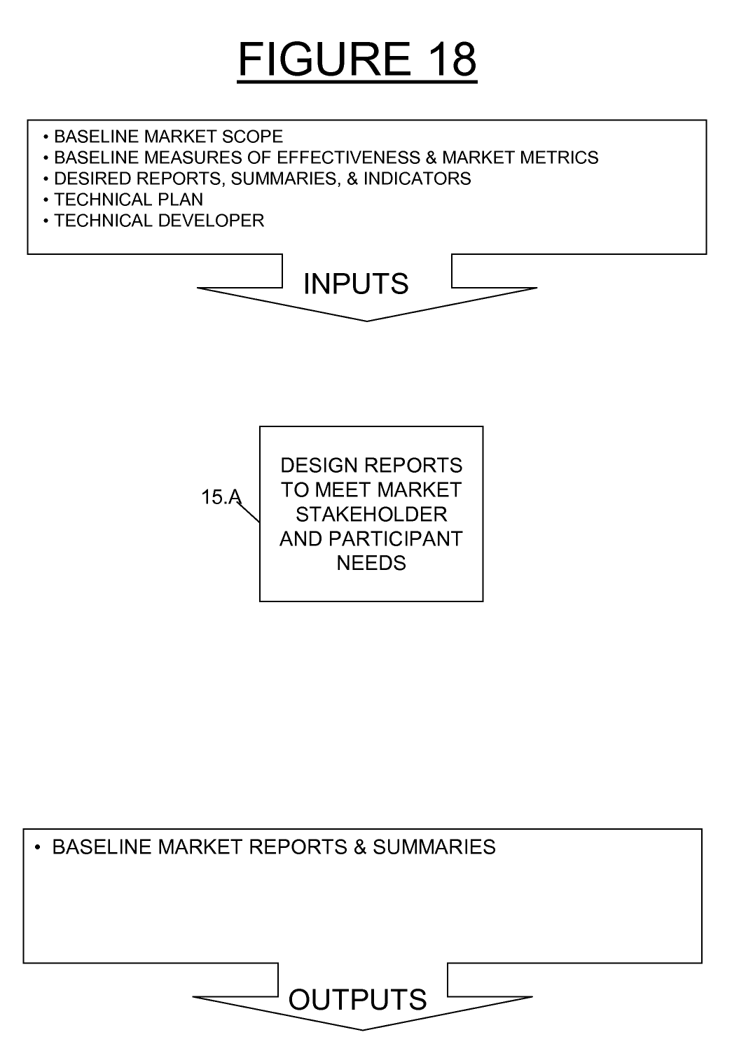

FIG. 18 is a flowchart illustrating reports and summaries process 15 steps, according to an embodiment of the present invention showing inputs and outputs. In step 15.A the requested reports and summaries are designed and developed for the e-management market. As mentioned in process 3 reports, summaries and indicators are directly tied to measures of effectiveness for individuals, organizations, the entire e-management market, or a sub-market. The metrics and indicators built into the process and templates respectively produce the inputs for the reports. These reports, summaries, and indicators are created for all levels of review by individuals, organizations, and stakeholders based on requested reports.

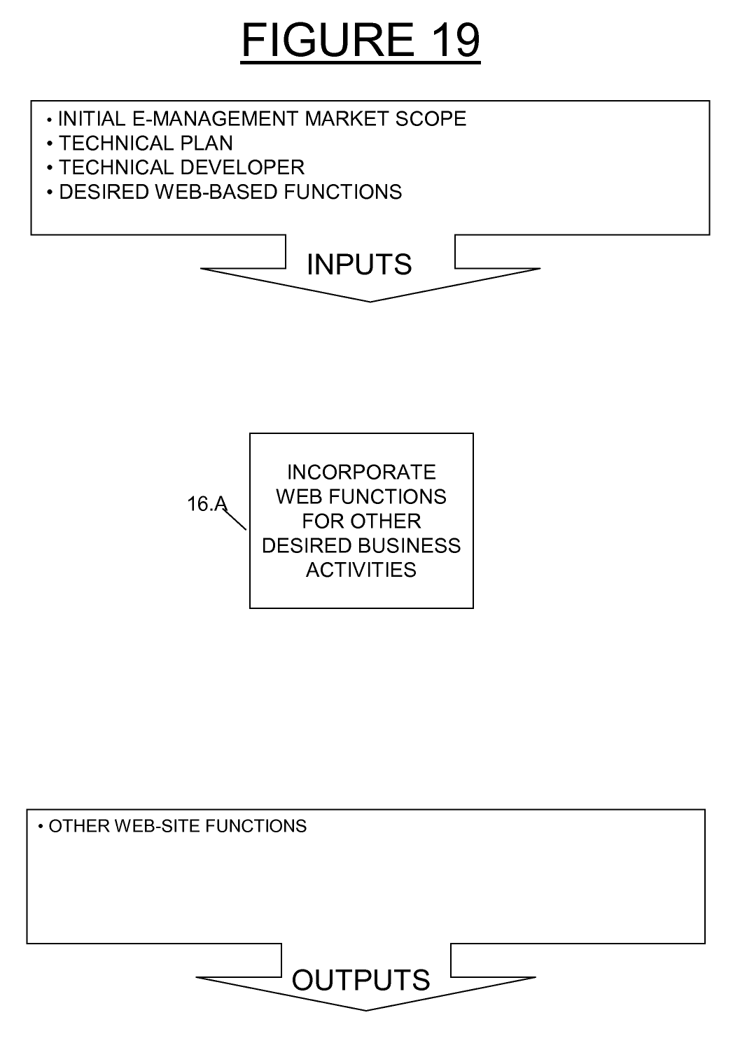

FIG. 19 is a flowchart illustrating other web-based functions process 16 steps, according to an embodiment of the present invention showing inputs and outputs. In step 16.A other web or portal functions are incorporated into the e-management market technical plan. These functions accomplish other business activities requested by the organization or community. Some examples of other web-based functions include blogs, email, chat rooms, e-rooms, video teleconferencing, knowledge repositories, and virtual libraries.

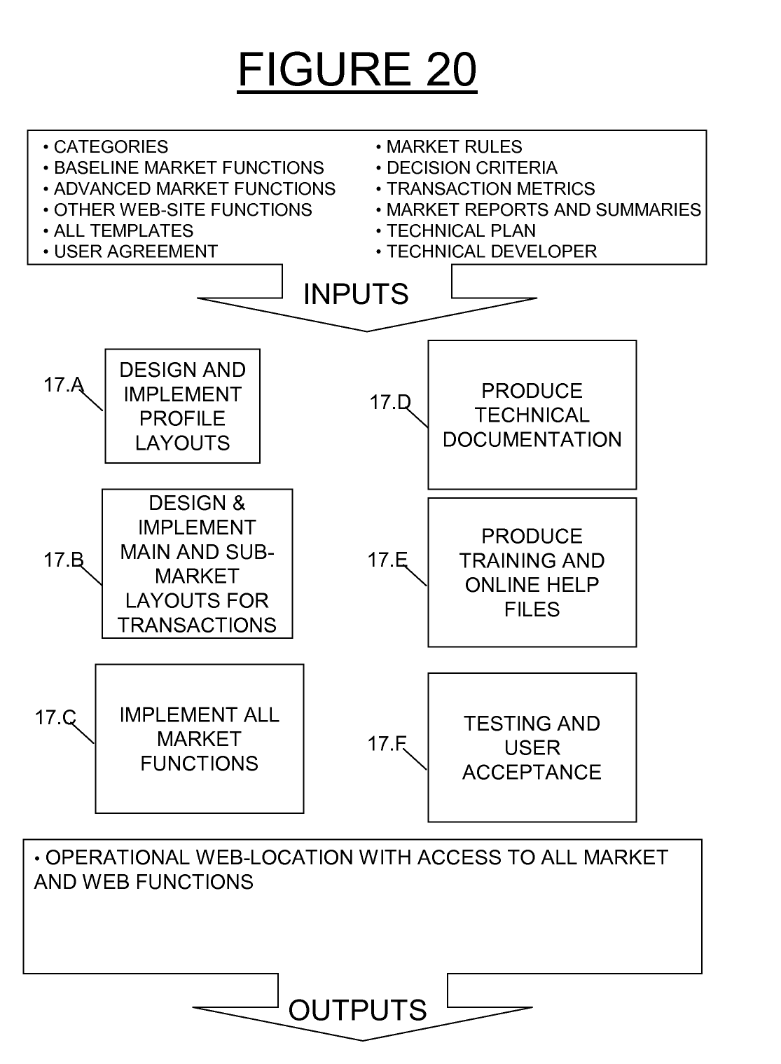

FIG. 20 is a flowchart illustrating web-based user interface implementation process 17 steps, according to an embodiment of the present invention showing inputs and outputs. In step 17.A profile layouts are designed and implemented in the e-management market location. Example profiles include individual, organizational, and capabilities. In step 17.B a main and sub-market layout is designed and implemented for transactions. In step 17.C all market functions, features, and templates that were developed in Process 10 through 15 and requested web functions from Process 16 are implemented in the e-management network location. In step 17.D a technical documentation describing all market functions, web-functions, designs, reports, etc is produced. In step 17.E training courseware and online help files are produced and implemented in the market location. In step 17.F the user is asked to test the e-management market and accept an initial operational capability. Refinements are made based on user and community testing feedback.

Operations Phase

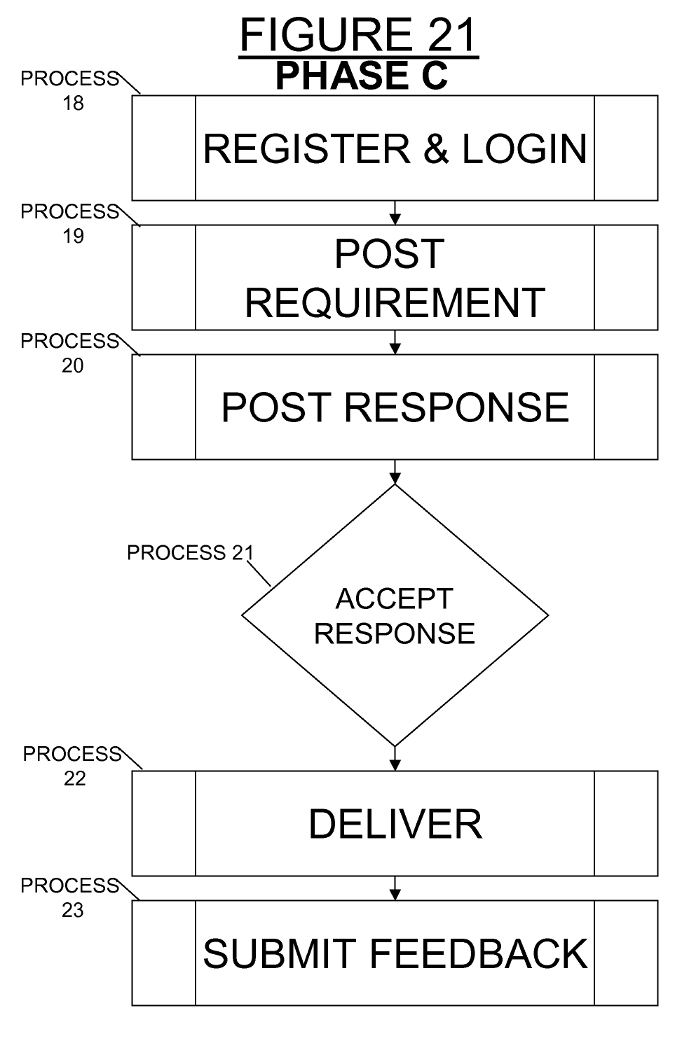

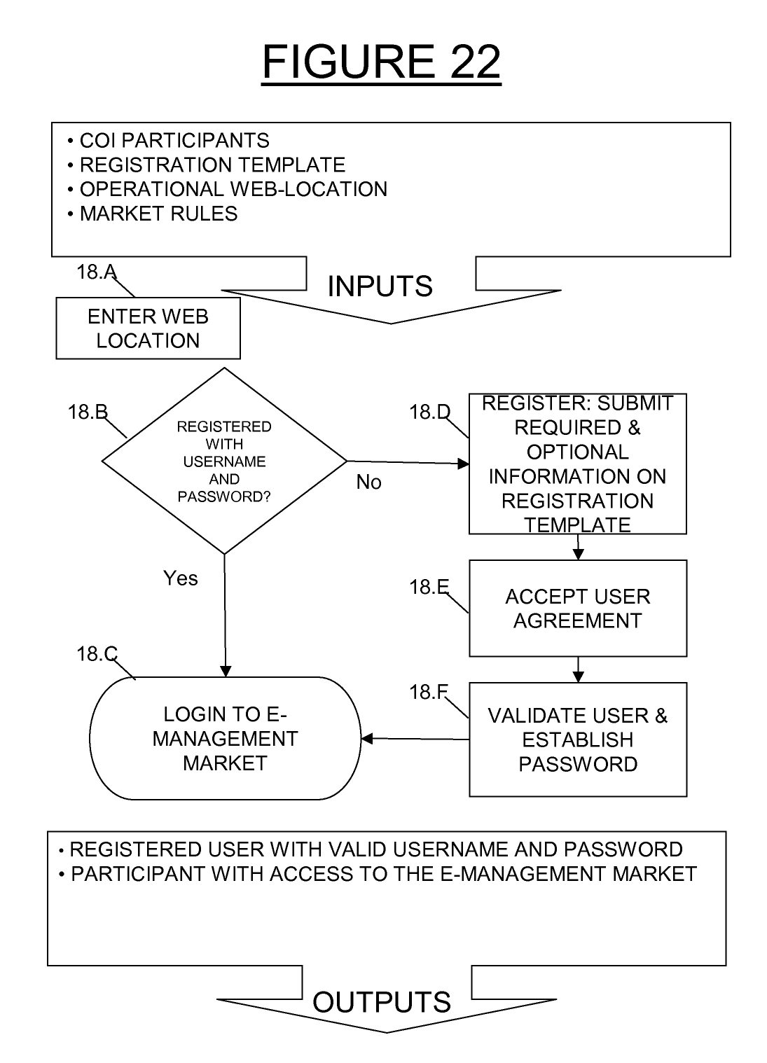

FIG. 21 is a flowchart illustrating operating phase C, according to an embodiment of the present invention. The operational phase has six processes and requires that the e-management market is implemented, operational, being maintained technically, and can be reached by intended participants FIG. 22 is a flowchart illustrating register and login process 18 steps, according to an embodiment of the present invention showing inputs and outputs. In step 18.A a user proceeds to a web location. In step 18.B if the user is registered in the e-management market they precede to step 18.C and login, otherwise the user proceeds to step 18.D and submits required information on registration templates. In step 18.E the e-management market presents the user acceptance statement, and the user accepts the agreement. In step 18.F the e-management market validates the user and establishes a password, that information is provided to the user, once the user receives the e-management market credentials, he may login.

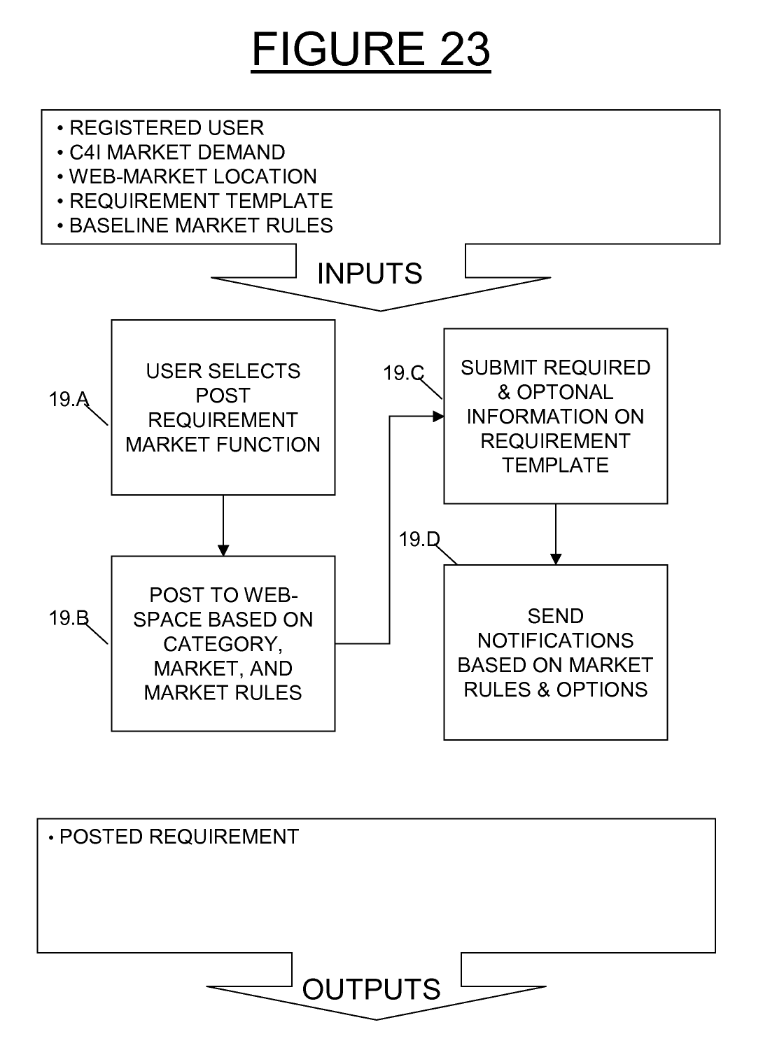

Processes 19 thru 23 include the elements of a reverse auction method applied to the e-management market. FIG. 23 is a flowchart illustrating post requirement process 19 steps, according to an embodiment of the present invention showing inputs and outputs. In step 19.A a logged-in e-management market participant with a requirement selects the link to the “post requirement” function. In step 19.B the user selects the location in the market to post this requirement by sub-market and category. Market rules may apply to requirement submission and are enforced by sub-market, category, and/or participant. In step 19.C the participant submits required and optional information as well as their decision criteria on the requirement template. In step 19.D the participant submits the requirement, at which time the requirement is posted to the market and notifications are sent based on the market rules and options that were selected on the requirement template.

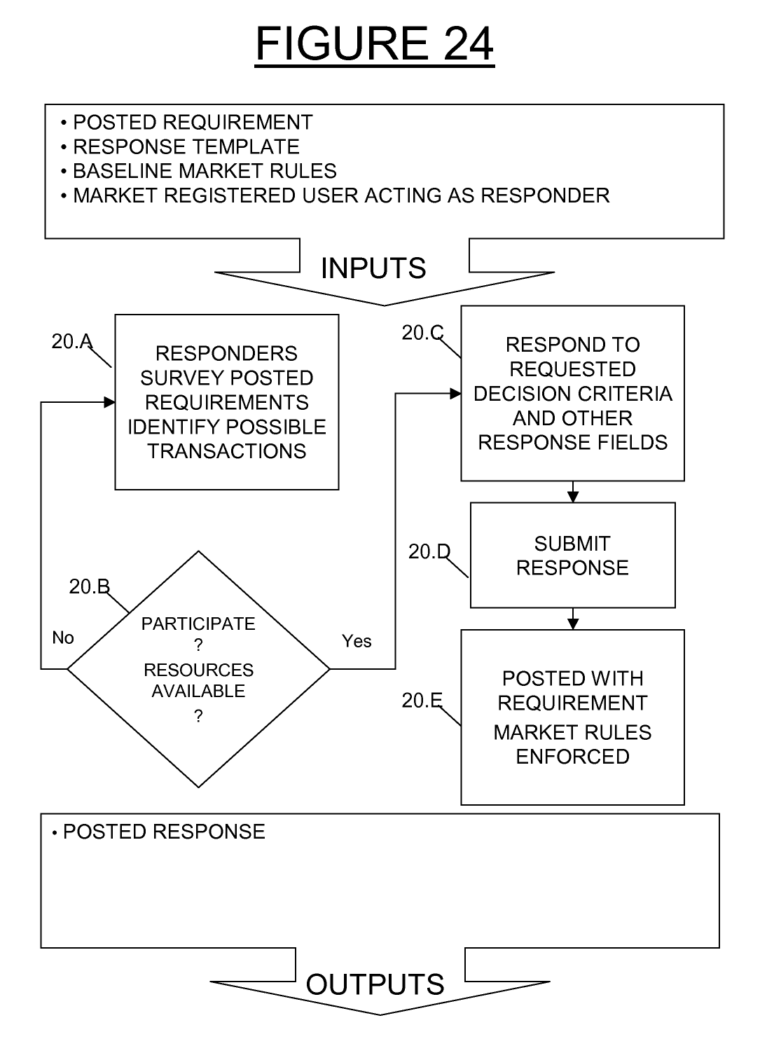

FIG. 24 is a flowchart illustrating post response process 20 steps, according to an embodiment of the present invention showing inputs and outputs. In step 20.A a logged-in e-management market participant surveys posted requirements and identifies one for which the participant may have a solution. The participant reviews the requirement, and pursues requirement clarification as necessary. In step 20.B the participant determines if resources are available to meet the requirement and if a proposal should be submitted. If the answer is no the participant returns to step 20.A and continues to survey requirements. If the answer is yes, the participant selects “post response” and proceeds to step 20.C. In step 20.C the participant responds with a complete description of the proposal and responds to all requested decision criteria and all required fields. In step 20.D the participant submits the proposal. In step 20.E the e-management market posts the proposal with the requirement, accomplishes notifications, and enforces market rules and options.

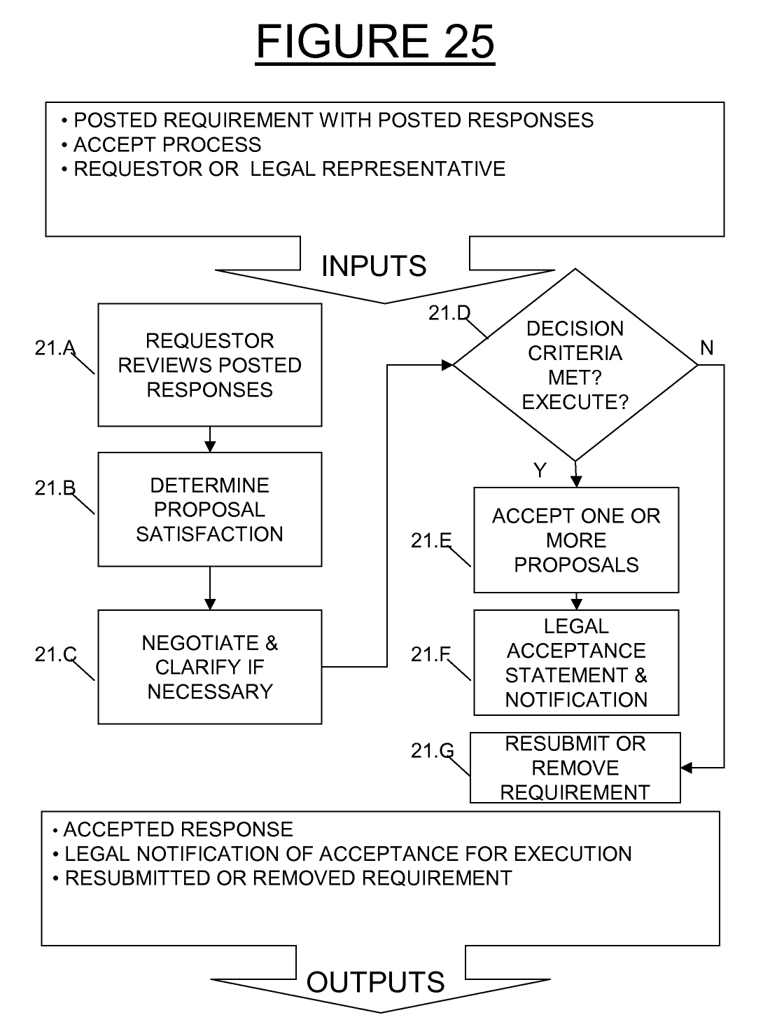

FIG. 25 is a flowchart illustrating the accept response process 21 steps, according to an embodiment of the present invention showing inputs and outputs. In step 21.A the requirement requester reviews the posted responses. In step 21.B the requester evaluates proposals to determine if they satisfy requirement needs. In step 21.C clarification and or negotiation is accomplished if necessary. In step 21.D the requester determines to execute or not based on decision criteria being met. If the requester decides not to execute, the requester moves to step 21.G. If the requester decides to execute, then in step 21.E one or more of the proposals is accepted. In step 21.F the e-management market issues a legal acceptance statement to the requester for approval: once approved, notifications of the legal transaction are sent. In step 21.G if the requester doesn't have any proposals, or is not satisfied with the existing proposals the requirement can be resubmitted to the e-management market or removed. In some cases a subject matter broker may be consulted to provide leads to help link requirement with responder.

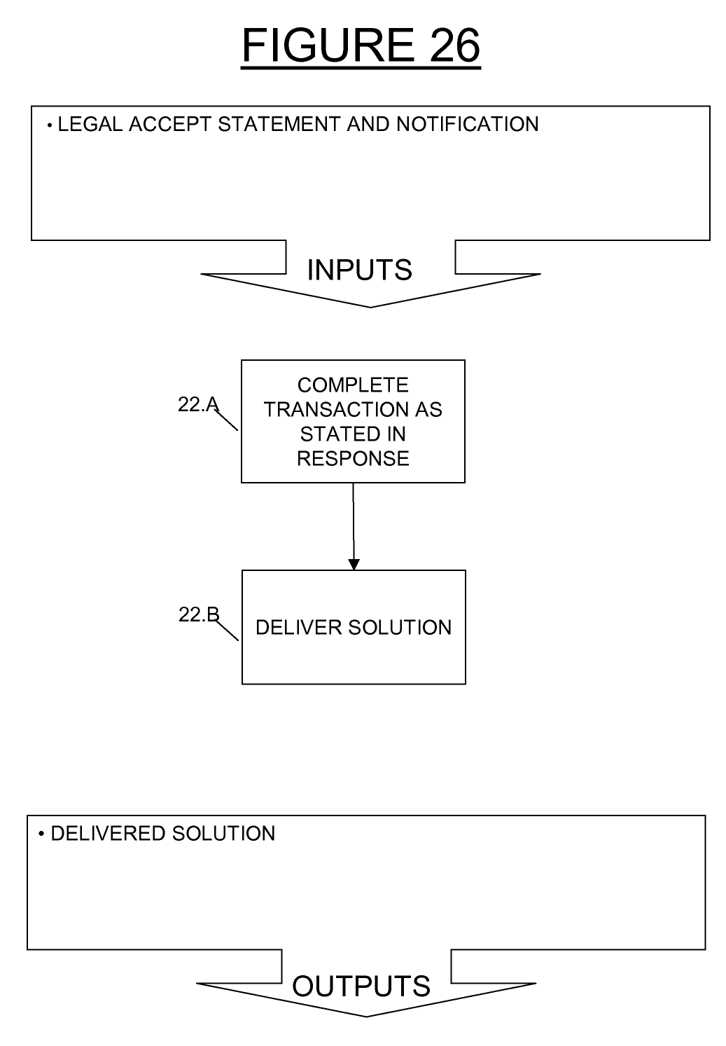

FIG. 26 is a flowchart illustrating deliver solution process 22 steps, according to an embodiment of the present invention showing inputs and outputs. In step 22.A the transaction is executed and performed as described in the requirement and response. In step 22.B the response is delivered or completed.

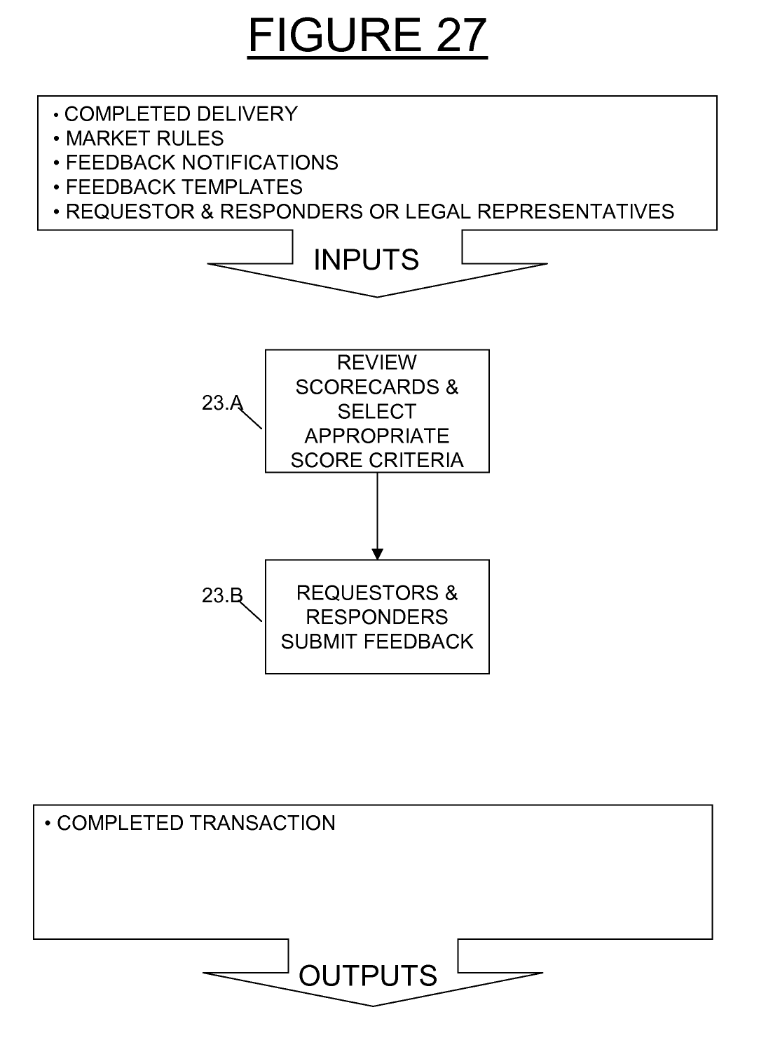

FIG. 27 is a flowchart illustrating submit feedback process 23 steps, according to an embodiment of the present invention showing inputs and outputs. In step 23.A the transaction requester and responder both review the feedback scorecards and determine their satisfaction with the completed transaction. They select the scores that reflect their satisfaction, and submit text feedback providing emphasis items. In step 23.B the transaction responder and requester turn in feedback by the date required by the e-management market, or they receive a degraded feedback submission score by the e-management market.

The operation of this reverse-auction market function effectively achieves self-synchronized supply and demand applied to the business process developed. A statement of demand is a powerful stimulant, especially when accompanied by an incentive to participate. By keeping requests out of one stovepipe channel and making them known to the entire e-management market, unplanned capabilities and resources provide solutions that wouldn't otherwise have been considered. This empowers the many to solve problems. Information and knowledge sharing markets offer reach to global resources, assets, and providers.

Life-Cycle Maintenance Phase

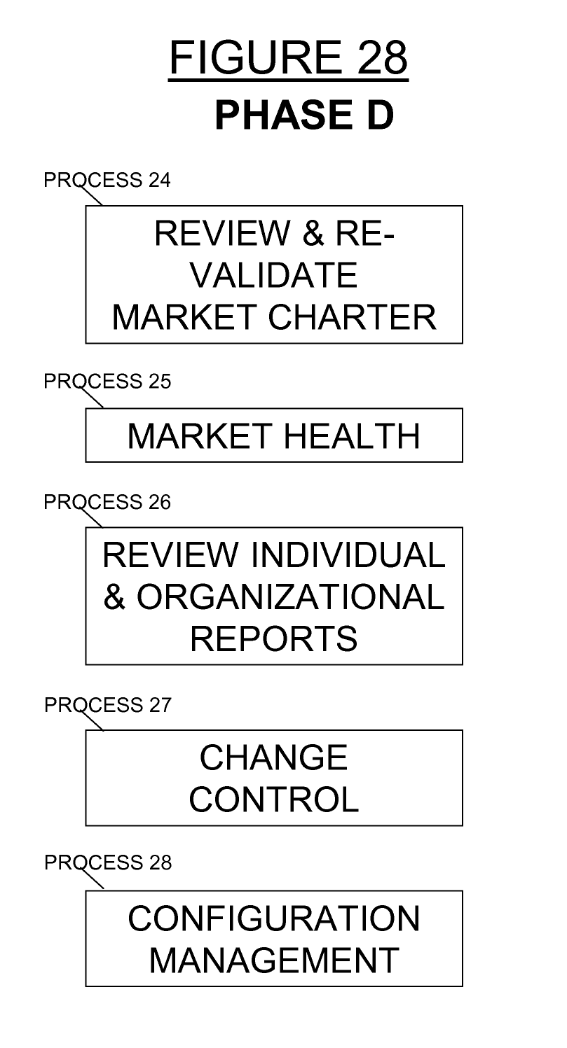

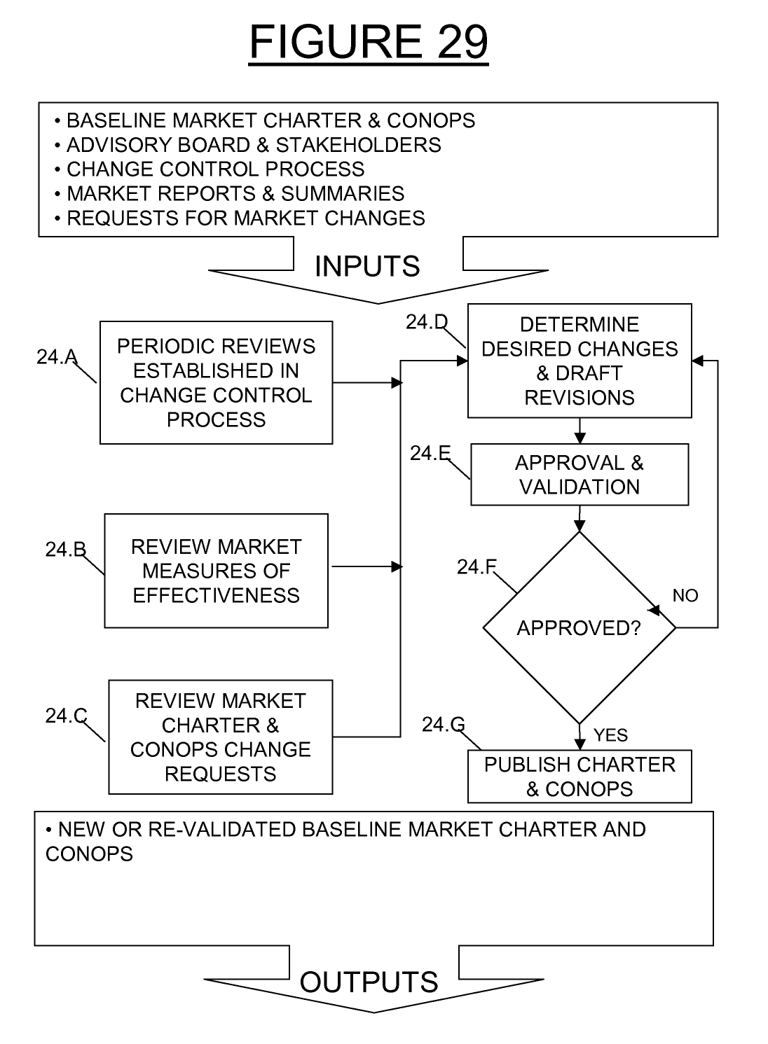

FIG. 28 is a flowchart illustrating life-cycle maintenance phase D, according to an embodiment of the present invention. There are five processes involved in this phase. FIG. 29 is a flowchart illustrating review and re-validate market charter process 24 steps, according to an embodiment of the present invention showing inputs and outputs. In step 24.A periodic reviews that were established in the change control process are accomplished. In step 24.B the advisory board reviews market measures of effectiveness. In step 24.C the change requests submitted to the e-management market are reviewed. In step 24.D the advisory board determines if e-management market changes are desired. If so desired, then a new draft charter is prepared. In step 24.E the draft charter is reviewed and validated according to the provisions of the change control process. In step 24.F if approved, the charter is published in step 24.G. If the charter is not approved, it is redrafted in step 24.D or returned to its original state.

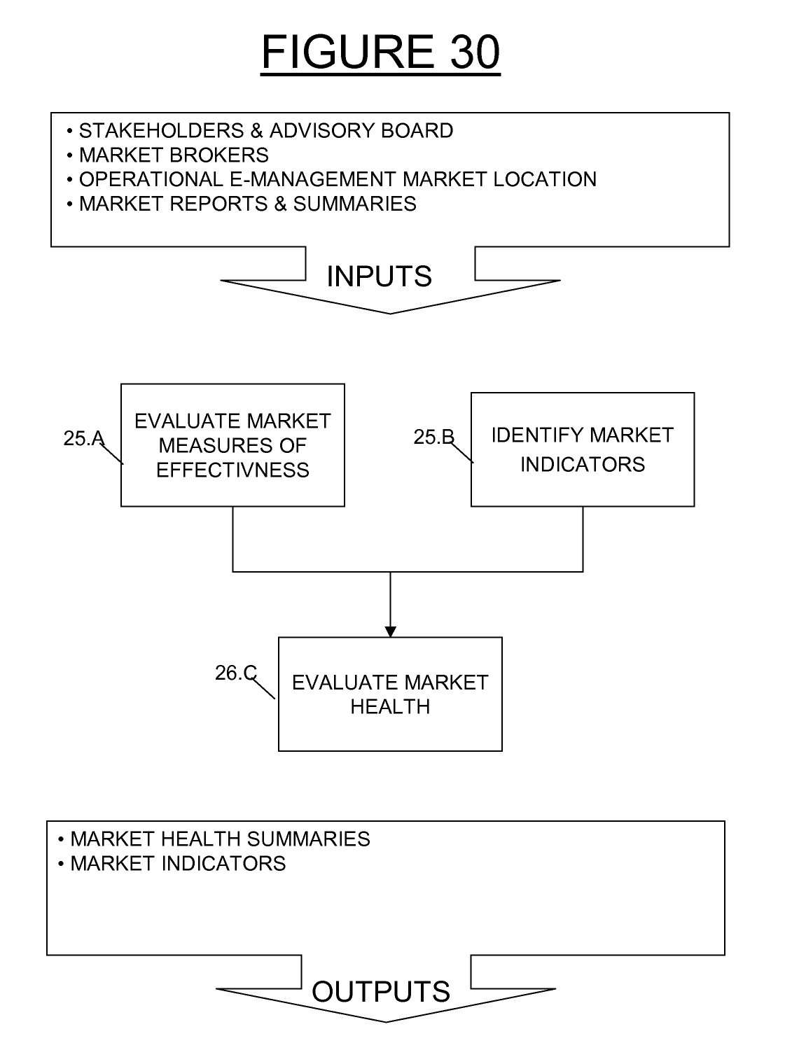

FIG. 30 is a flowchart illustrating market health process 25 steps, according to an embodiment of the present invention showing inputs and outputs. In step 25.A the advisory board executes the market reports and summaries to evaluate the e-management measures of effectiveness. In step 25.B market indicators are identified and summarized. In step 25.C the same reports and indicators are evaluated to determine market health. Examples of market health include the number of met or unmet requirements; used, unused or underused capacity, and general levels of satisfaction in effectiveness. The point of these reviews is to establish how well the e-management market is meeting community mission objectives.

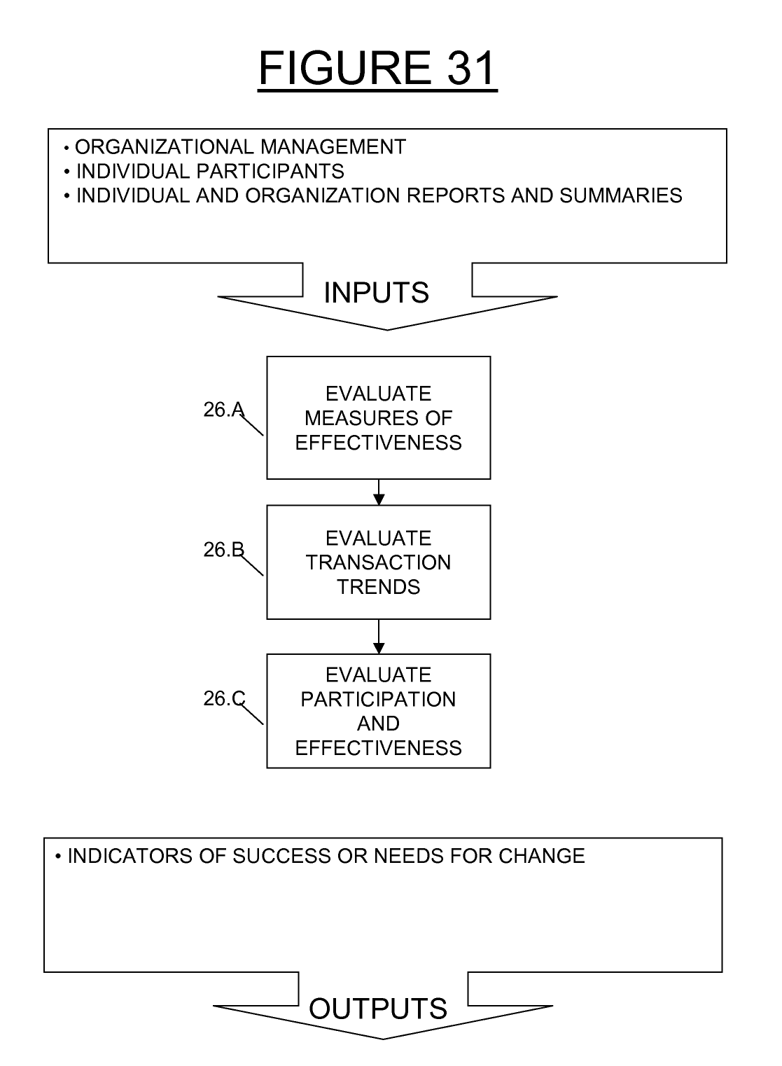

FIG. 31 is a flowchart illustrating individual & organizational reports & summaries process 26 steps, according to an embodiment of the present invention showing inputs and outputs. In step 26.A e-management market participants execute reports and summaries designed to show individual and organizational measures of effectiveness. In step 26.B participants identify and evaluate their transaction performance trends. In step 26.C participation and effectiveness are evaluated by participants. The point of these reviews is to evaluate personal or organizational performance in accomplishing community mission objectives.

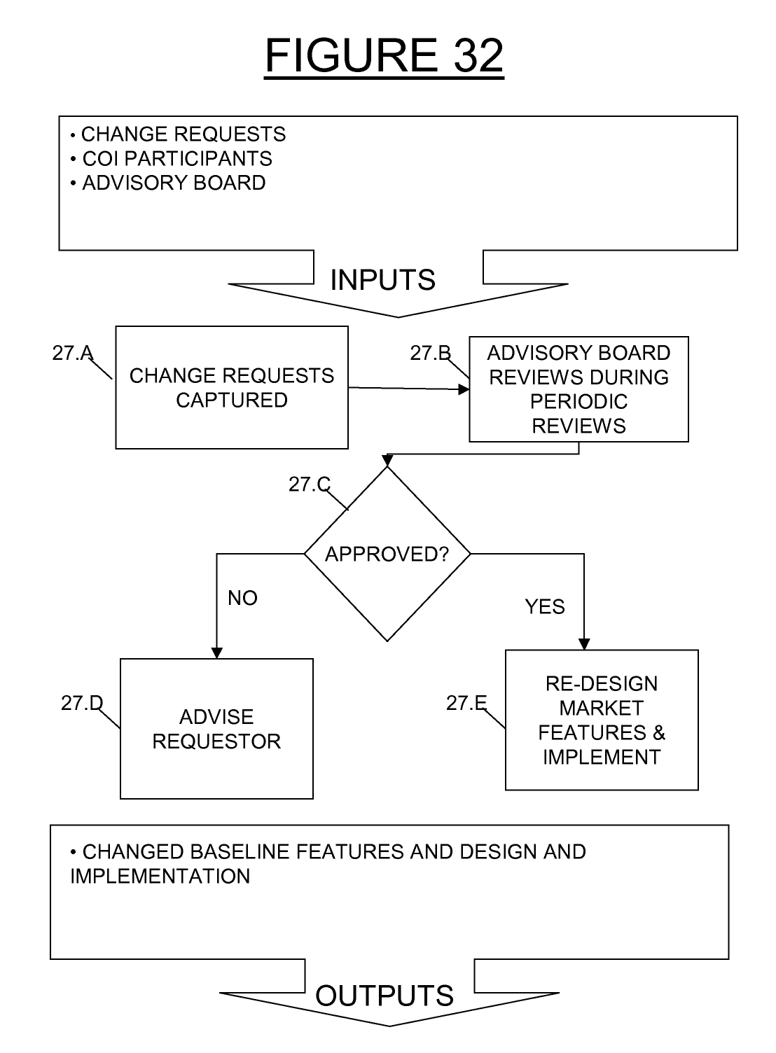

FIG. 32 is a flowchart illustrating change control process 27 steps, according to an embodiment of the present invention showing inputs and outputs. In step 27.A change requests are captured from COI participants during market operations and from stakeholder and advisory board inputs. In step 27.B the advisory board reviews all change requests and makes recommendation for changes. In step 27.C the change approval process is executed. If the change request is approved step 27.E is executed and market feature changes are designed and implemented. If the change request is not approved, then the requester is advised of the result in step 27.D.

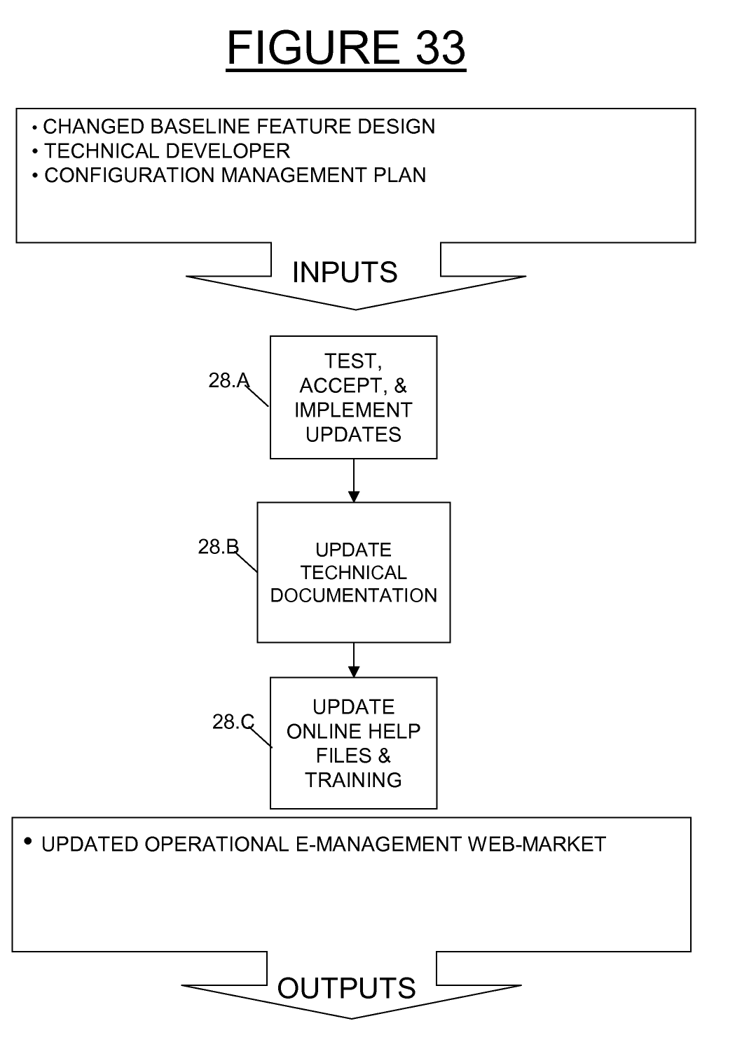

FIG. 33 is a flowchart illustrating configuration management process 28 steps, according to an embodiment of the present invention showing inputs and outputs. In step 28.A market updates are completed, tested, and implemented. In step 28.B the e-management market technical documentation is updated. In step 28.C online help files and training materials are updated to reflect changes.

An example e-management market is available at www.c4imarkets.com and demonstrates a disaster response market. Provisional Application Ser. No. 60/733,718 filed Nov. 4, 2005 is incorporated by reference.

Having described the processes, steps, and strategy of my invention, it should be apparent to those skilled in the art that the invention can be modified without departing from the strategy, spirit, and scope of the invention. I claim all modifications coming within the strategy, spirit, and scope of the invention.

What is claimed is:

1. A method for developing, operating, and maintaining an e-management market using e-commerce practices.

2. The method of claim 1, wherein said development comprises:
(a) identifying the presence of market basics;
(b) identifying business activities and market scope;
(c) defining success for said e-management market and tying to participation incentives;
(d) defining measures of effectiveness for individual, organizations, and capabilities;
(e) planning, designing and developing e-management market functions and features based on e-commerce equivalents; and
(f) implementing all functionality and features for said e-management market with a web-based user interface in a network location.

3. The method according to claim 1, where in said e-commerce practice is a reverse-auction and said business activities comprise: command and control, information sharing, task management, course of action selection, or knowledge management whereby self-synchronization is achieved.

4. The method of claim 1, wherein developing and operating market functions and features provide a calculated value for intangible assets and resources such as information or knowledge.

5. The method of claim 1, wherein developing and operating reports and summaries, feedback and metrics provide measures of organizational, individual, and community performance and effectiveness.

6. The method of claim 1, wherein developing market functions and features provide reach to unplanned global resources to meet requirements.

7. The method of claim 1, wherein developing and using value added broker roles and responsibilities for subject matter experts and middle management increase transactions.

8. The method of claim 1, wherein developing a value method records all resources represented in a transaction and establishes a market “price” or value.

9. The method of claim 1 providing participation incentives by using recorded market results in performance reports, award criteria, published listings, and to determine organizational budget and manning for future years.

10. A method of obtaining requested information in an Internet system composed of a requester and a plurality of qualified responders which comprises:
(a) said requester transmitting on said Internet system to said plurality of qualified responders a request for information proposal in a common format from each said qualified responder;
(b) at least one qualified responders independently responding via said Internet system with a proposed answer to said requester;
(c) evaluating the benefit of each said responses to said request; and
(d) awarding a non-monetary award for chosen responses based on the benefice of such answer.

11. A method in accordance with claim 10, wherein said same request is a request for information relative to a problem that said requester needs to solve and said benefice of awarded for said answer reflects the value of said answer to said requester in solving said problem.

12. A method in accordance with claim 10, wherein said Internet system is limited to communications within a single organization.

13. A method in accordance with claim 10, wherein said organizations are military.

14. A method in accordance with claim 10, wherein said organizations consists of federal, state, county, and municipal organizations or a combination thereof.

15. A method in accordance with claim 10, wherein said Internet System is limited to use by organizations which are authorized participants.

16. A method for organizing and conducting response, planning, or exercise activities for dealing with a defined widespread disaster, which comprises:
(a) preparing a first register of all federal, state, county and municipal decision-making entities which have authority to request services and goods needed to respond to said disaster;
(b) providing for said register a communication means capable of sending and receiving communications by all parties in said first register;
(c) preparing a second register of bodies having capacity to provide said services and goods needed to respond to said disaster;
(d) providing for said bodies in said second register the communication means for receiving and responding to requests from parties in said first register;
(e) said parties of said first register requesting services and goods to a plurality of said bodies;
(f) said bodies responding to said requests of their capabilities to provide said services and said goods to said parties at the time of said activities; analyzing said requests and responses made in said activity for sufficiency to meet the needs of said disaster; and
(g) adjusting the means for providing the services and goods required to meet the needs of said disaster based on insufficiencies determine by said analysis of the responses.
